(19) United States
(12) Patent Application Publication
(10) Pub. No.: US 2025/0228262 A1
(43) Pub. Date: Jul. 17, 2025

(54) LOW SUGAR, HIGH FIBER CHEWABLE SWEETS

(71) Applicant: TATE & LYLE SOLUTIONS USA LLC, Hoffman Estates, IL (US)

(72) Inventor: Sanjiv H. AVASHIA, Hoffman Estates, IL (US)

(21) Appl. No.: 18/854,206

(22) PCT Filed: May 5, 2023
(86) PCT No.: PCT/GB2023/051208

§ 371 Date: Oct. 4, 2024

Related U.S. Application Data
(60) Provisional application No. 63/339,244, filed on May 6, 2022.

(51) Int. Cl. A23G 3/42; A23G 3/36; A23G 3/44

(52) U.S. Cl. CPC A23G 3/42; A23G 3/368; A23G 3/44

(57) ABSTRACT

Gummies comprising soluble fiber in an amount of from about 40% to about 90% by weight on a dry solids basis; a gelling agent in an amount of from about 1% to about 25% by weight on a dry solids basis; a low-molecular weight saccharide or sugar alcohol in an amount of from about 1% to about 45% by weight on a dry solids basis; and water; wherein the gummy has a total dry solids content of from about 75% to about 90%, which exhibit an excellent set and excellent long-term storage, and methods of preparing same.

### FIELD OF THE INVENTION

The present invention relates to gummies comprising soluble fiber, low-molecular weight saccharides and/or sugar alcohols and a gelling agent, and to methods for preparing gummies comprising soluble fiber, low-molecular weight saccharides and/or sugar alcohols and a gelling agent.

### BACKGROUND

Gummies (also known as gummis, gummi candies, gummy candies, jelly sweets or chewable sweets) are a popular type of confectionery and are a convenient and increasingly popular way to deliver pharmaceuticals or nutraceuticals (also known as dietary supplements).

Gummies typically take the form of a hydrocolloid system of corn syrup, sucrose, gelatin, starch and water, optionally with minor amounts of colorants, flavorants, sweeteners, or other food additives or nutraceuticals. The gelatin, corn syrup, sucrose and starch are responsible for providing the physical properties that make the gummy appealing to the consumer, such as high elasticity and low stickiness. However, they are also nutritive and contribute to the caloric content of the gummy. Moreover, excess intake of nutritive sweeteners such as corn syrup and sugar has long been associated with diet-related health issues, such as obesity, heart disease, metabolic disorders and dental problems. Accordingly, consumers are increasingly looking for ways to decrease the amount of nutritive sweeteners in their diets. Manufacturers are responding to this demand by seeking to develop replacements for nutritive sweeteners that are better able to mimic the desirable taste and functional properties of the nutritive sweeteners.

Numerous strategies have been employed to partially or totally replace nutritive sweeteners in various food types.

One strategy is to use ‘high potency sweetener’ or ‘high intensity sweeteners’. Sweeteners falling within this class have a sweetness many times that of sucrose, such that only very small amounts are needed to provide an equivalent level of sweetness to that of the nutritive sweetener being replaced. High potency sweeteners typically require the addition of a bulking agent (for example, a non-sweet saccharide polymer such as maltodextrin), and generally fail to provide the same physical properties as the nutritive sweetener being replaced.

Another strategy is to use ‘sugar alcohols’ or ‘polyols’ (for example, erythritol, xylitol, sorbitol, maltitol etc.). These sweeteners are generally able to provide a degree of calorie reduction (by way of example, sorbitol provides about 2.6 kcal/g compared to about 4 kcal/g for sucrose) while also providing bulk, but they generally do not provide the same physical properties as the nutritive sweetener being replaced.

Another strategy is to use alternative saccharides that provide some sweetness and bulk but which do not contribute the same caloric content as traditional nutritive sweeteners. Examples of these alternative saccharides are rare sugars such as allulose and tagatose. Alternative saccharides are ideal as candidates for sugar replacement because they can provide the closest taste and textural to nutritive sweeteners, but the differences between the chemical and physical properties of different saccharides mean that alternative saccharides typically need to be formulated with additional sweeteners or other additives. A one-to-one replacement of nutritive sweeteners with a non-nutritive sweetener that is indistinguishable from nutritive sweeteners in all applications remains elusive.

At the same time, dietary fiber is increasingly sought after as a food ingredient or food supplement for its effects on improved laxation, prebiotic benefits, favorable blood glucose and insulin response, and potentially benefits for bone health. Dietary fibers are the portion of plant-derived food that cannot be completely broken down by human digestive enzymes. The United States Depart of Agriculture recommends a fiber intake of up to 14 grams per 1,000 calories of food, meaning that a moderately active adult male should consume at least 30.8 grams of fiber per day, whereas a moderately active adult female should consume at least 25.2 grams of fiber per day. On average, American adults eat only 10 to 15 grams of fiber per day. There therefore exists a need to provide a convenient format for increasing dietary fiber intake.

It would also be desirable to provide a gummy which: provides the high elasticity, low surface stickiness and low interior stickiness expected from a gummy; and contains a source of fiber; and/or has a lower nutritive sweetener content than known gummies.

### SUMMARY OF THE INVENTION

The present invention relates to gummies comprising soluble fiber, low-molecular weight saccharides and/or sugar alcohols and a gelling agent, and to methods for preparing gummies comprising soluble fiber, low-molecular weight saccharides and/or sugar alcohols and a gelling agent. The present invention is based on the finding that such gummies: exhibit an excellent set; provide the high elasticity, low surface stickiness, and low interior stickiness expected from gummies; and contain a source of fiber; and/or have a lower nutritive sweetener content than known gummies.

In particular, the invention provides a gummy comprising:
soluble fiber in an amount of from about 40% to about 90% by weight on a dry solids basis;
a gelling agent in an amount of from about 1% to about 25% by weight on a dry solids basis;
a low-molecular weight saccharide or sugar alcohol in an amount of from about 1% to about 45% by weight on a dry solids basis; and water;
wherein the gummy has a total dry solids content of from about 75% to about 90% by weight.

The invention also provides a gummy comprising:
fructo-oligosaccharides (FOS) in an amount of from about 40% to about 99% by weight on a dry solids basis;
a gelling agent in an amount of from about 1% to about 25% by weight on a dry solids basis; and
water;
   wherein the gummy has a total dry solids content of from about 75% to about 90%. The gummy may include a low-molecular weight saccharide or sugar alcohol in an amount of from about 1% to about 45% by weight on a dry solids basis.

The invention also provides a process for preparing a gummy comprising the steps of:
a) dispersing a soluble fiber; one or more low-molecular weight saccharides, sugar alcohols, or a combination thereof; a gelling agent in water to provide a gelling composition having:
a soluble fiber in an amount of from about 40% to about 90% by weight on a dry solids basis;
a gelling agent in an amount of from about 1% to about 25% by weight on a dry solids basis;
a low-molecular weight saccharide or sugar alcohol in an amount of from about 1% to about 45% by weight on a dry solids basis; and
b) drying the gelling composition to provide a gummy having a total dry solids content of from about 75% to about 90%.

The invention also provides a process for preparing a gummy comprising the steps of:
a) dispersing FOS and a gelling agent in water to provide a gelling composition having:
FOS in an amount of from about 40% to about 99% by weight on a dry solids basis;
a gelling agent in an amount of from about 1% to about 25% by weight on a dry solids basis; and
   b) drying the gelling composition to provide a gummy having a total dry solids content of from about 75% to about 90%. A low-molecular weight saccharide or sugar alcohol may also be added in step a) to give a gelling composition having a low-molecular weight saccharide or sugar alcohol in an amount of from about 1% to about 45% by weight on a dry solids basis

### BRIEF DESCRIPTION OF DRAWINGS

FIG. 1 shows the results of texture analysis of gummies according to Example 4.

FIG. 2 shows the hardness of gummies according to Examples 4 to 12 over time.

FIG. 3 shows the work of adhesion of gummies according to Examples 4 to 12 over time.

FIGS. 4a and 4b respectively show photographs of gummies according to Examples 1 and 2 after 11 months.

FIGS. 5a and 5b respectively show photographs of gummies according to Example 12 after 18 months and Example 18 after 11 months.

FIG. 6 shows a photograph of gummies according to Example 20 after 18 months.

FIG. 7 shows a photograph of gummies according to Example 25.

FIG. 8 shows a photograph of gummies according to Example 26.

FIG. 9 shows a photograph of gummies according to Example 27.

FIG. 10 shows a photograph of gummies according to Comparative Example 3.

FIG. 11 shows the results of the sensory experiments reported in Example 30.

FIG. 12 shows the results of the sensory experiments reported in Example 30.

### DETAILED DESCRIPTION

The present inventors have found that gummies comprising soluble fiber, a gelling agent; a low-molecular weight saccharide or sugar alcohol, water, and one or more optional additional ingredients exhibit an excellent set; provide the high elasticity, low surface stickiness, and low interior stickiness expected from gummies; and act as a source fiber and have a lower caloric content than conventional gummies.

In one aspect, the present invention provides a gummy comprising:
a soluble fiber in an amount of from about 40% to about 90% by weight on a dry solids basis;
a gelling agent in an amount of from about 1% to about 25% by weight on a dry solids basis;
a low-molecular weight saccharide or sugar alcohol in an amount of from about 1% to about 45% by weight on a dry solids basis; and
water;
wherein the gummy has a total dry solids content of from about 75% to about 90%.

In another aspect, the present invention provides a gummy comprising:
fructo-oligosaccharides (FOS) in an amount of from about 40% to about 99% by weight on a dry solids basis;
a gelling agent in an amount of from about 1% to about 25% by weight on a dry solids basis; and
water;
   wherein the gummy has a total dry solids content of from about 75% to about 90%. The gummy may include a low-molecular weight saccharide or sugar alcohol in an amount of from about 1% to about 45% by weight on a dry solids basis.

In another aspect, the present invention provides a process for preparing a gummy comprising the steps of:
a) dispersing a soluble fiber; one or more low-molecular weight saccharides, sugar alcohols, or a combination thereof; a gelling agent in water to provide a gelling composition having:
a soluble fiber in an amount of from about 40% to about 90% by weight on a dry solids basis;
a gelling agent in an amount of from about 1% to about 25% by weight on a dry solids basis;
a low-molecular weight saccharide or sugar alcohol in an amount of from about 1% to about 45% by weight on a dry solids basis; and
b) drying the gelling composition to provide a gummy having a total dry solids content of from about 75% to about 90%.

In another aspect, the present invention provides a process for preparing a gummy comprising the steps of:
a) dispersing fructo-oligosaccharides (FOS) and a gelling agent in water to provide a gelling composition having:
FOS in an amount of from about 40% to about 99% by weight on a dry solids basis;
a gelling agent in an amount of from about 1% to about 25% by weight on a dry solids basis; and
b) drying the gelling composition to provide a gummy having a total dry solids content of from about 75% to about 90%. A low-molecular weight saccharide or sugar alcohol may also be added in step a) to give a gelling composition having a low-molecular weight saccharide or sugar alcohol in an amount of from about 1% to about 45% by weight on a dry solids basis.

### Soluble Fiber

Soluble fibers (also known as soluble dietary fibers) are a class of polysaccharides that are soluble in water and resist digestion by digestive enzymes in the small intestine and pass into the large intestine where they can be fermented. Soluble fibers are an attractive way of introducing fiber into the diet because they are water soluble and can be incorporated into other water-based foods.

In the aspects of the present invention, any soluble fiber may be employed as the soluble fiber. Examples of soluble fiber that are suitable for use in the invention are polydextrose, hydrogenated polydextrose, soluble corn fiber, fructans, galactooligosaccharides, resistant dextrin, galactomannans, hydrolyzed galactomannans.

Polydextrose (PDX) is a polysaccharide of D-glucose, sorbitol and citric acid units. It is a digestion-resistant soluble fiber. Hydrogenated PDX (HPDX) is obtained by hydrogenation of PDX which reduces most terminal D-glucose units and remaining D-glucose monomer in the PDX to sugar alcohols. Suitable commercial SCF products include STA-LITE® Polydextrose, STA-LITE® 370, STA-LITE® II, STA-LITE® III F, all available from Tate & Lyle Health & Nutrition Sciences, Hoffman Estates, IL.

Soluble corn fiber (SCF) (also known as resistant maltodextrin) is a polysaccharide of D-glucose units. SCF differs from maltodextrin by the presence of α(1→6), α(1→2), α(1→3), or beta glycosidic linkages. The presence of these linkages contributes to the low digestibility of the SCF. In certain embodiments, the oligosaccharides of the SCF have an average degree of polymerization of at least about 5, at least about 7, or at least about 9. For example, in certain embodiments of the methods and compositions described herein, the oligosaccharides of the SCF have an average degree of polymerization in the range of about 5 to about 20, about 7 to about 20, or about 9 to about 20. In other embodiments, the oligosaccharides of the SCF have an average degree of polymerization in the range of about 5 to about 15, about 7 to about 15, or about 9 to about 15. For example, in one embodiment of the methods and compositions described herein, the oligosaccharides of the SCF have an average degree of polymerization of about 10.

Suitable commercial SCF products include PROMITOR® Soluble Corn Fiber 70 (minimum fiber content of about 70%, maximum mono- and disaccharide content of about 20%), and PROMITOR® Soluble Corn Fiber 85 (minimum fiber content of about 85%, maximum mono- and disaccharide content of about 2%), PROMITOR® Soluble Corn Fiber 85L, and PROMITOR® Soluble Fiber 85B L, all available from Tate & Lyle Health & Nutrition Sciences, Hoffman Estates, IL; FIBERSOL® 2 available from ADM.

Certain SCFs suitable for use in the methods and compositions described herein are described further in U.S. Patent Applications Publications Nos. 2008/0292766, 2006/0210696 and 2008/0175977, each of which is incorporated herein by reference in its entirety. In certain embodiments of the methods and compositions described herein, the SCF is as described in an aspect or embodiment of U.S. Patent Application Publication Nos. 2008/0292766, 2006/0210696 or 2008/0175977.

In certain embodiments, the soluble fiber is the SCF produced by a process described in Examples 1, 2 or 4 to 9 of U.S. Pat. No. 7,608,436, which examples are incorporated herein by reference in their entirety. For example, in one embodiment, the process to produce soluble uses an aqueous feed composition that comprises at least one monosaccharide or primarily α(1→4)-linked oligosaccharide, and that has a solids concentration of at least about 70% by weight. The feed composition is heated to a temperature of at least about 40° C., and is contacted with at least one catalyst that accelerates the rate of cleavage or formation of glucosyl bonds for a time sufficient to cause formation of α(1→6), α(1-2), α(1→3), or beta glycosidic linkages. In one particular embodiment, the process includes heating an aqueous feed composition that comprises at least one monosaccharide or primarily α(1→4)-linked oligosaccharide, and that has a solids concentration of at least about 70% by weight, to a temperature of at least about 40° C.; and contacting the feed composition with at least one catalyst that accelerates the rate of cleavage or formation of glucosyl bonds for a time sufficient to cause formation of an oligosaccharide comprising α(1→6), α(1→2), α(1→3), or beta glycosidic linkages, wherein a product composition is produced that contains a higher concentration of oligosaccharides comprising α(1→6), α(1→2), α(1→3), or beta glycosidic linkages than primarily α(1→4)-linked oligosaccharides; wherein the product composition comprises oligosaccharides comprising α(1→6), α(1→2), α(1→3), or beta glycosidic linkages having a degree of polymerization of at least three in a concentration of at least about 20% by weight on a dry solids basis. In certain such embodiments, the product composition that is produced contains a higher concentration of oligosaccharide comprising α(1→6), α(1-2), α(1→3), or beta glycosidic linkages than primarily α(1→4)-linked oligosaccharides. In one embodiment of the process, the at least one catalyst is an enzyme that accelerates the rate of cleavage or formation of glucosyl bonds. In another embodiment of the process, the at least one catalyst is an acid. In some embodiments of the process, acid and enzyme can be used in sequence, with the feed composition first being treated with enzyme and subsequently with acid, or vice versa.

In other embodiments, the soluble fiber is the SCF produced by a process described in paragraphs [0051] to [0075] of International Patent Application No. WO 2014/153554 A1, which paragraphs are incorporated herein by reference in their entirety.

Resistant dextrins (RD) are short chain soluble polysaccharides of D-glucose units. RD differs from maltodextrin by the presence of α(1-+6), α(1-+2), α(1-+3), or beta glycosidic linkages. The presence of these linkages contributes to the low digestibility of the RD.

When PDX, SCF or RD are used, they may exhibit a linkage pattern comprising 25-45% terminally-linked glucopyranosyl residues; 10-22% 6-linked glucopyranosyl residues; 13-32% 4-linked glucopyranosyl residues; 2-11% 3,1-linked glucopyranosyl residues; 3-13% 4, 6-linked glucopyranosyl residues; 1-5% 3,6-linked glucopyranosyl residues; and 0.5-4% 2, 4-linked glucopyranosyl residues.

Linkage patterns can be determined using the method of York et al., Methods Enzymol. 116, 3-40 (1985), which is incorporated herein by reference in its entirety. The method proceeds by permethylating the oligosaccharide, followed by quantitative hydrolysis and acetylation. This results in monomeric species that are acetylated where they were bound to other residues in the oligosaccharide, and methylated everywhere else. The mixture of the monomeric species can be analyzed by gas chromatography to determine relative amounts of different types of linked monomers.

As used herein, a terminal residue is a residue that has only a single linkage to the rest of the oligosaccharide of which it is a part. A 1,X-linked residue is one that is linked to the rest of the oligosaccharide of which it is a part at through its 1-position and its X-position (i.e., to two other residues). A 1,X,Y-linked residue is one that it is linked to the rest of the oligosaccharide of which it is a part through its 1-position, its X-position, and its Y-position (i.e., to three other residues). As used herein, the term “oligosaccharide” includes disaccharides, trisaccharides, and oligomers of higher degrees of polymerization up to 30. Linkage percentages are provided as the fraction of the total number of terminally-linked residues, di-linked residues and tri-linked residues. Linkage patterns may be determined by any other conventional means in the art.

In an embodiment, the soluble fiber is made by a process comprising heating an aqueous feed composition that comprises at least one monosaccharide or primarily α(1-4)-linked oligosaccharide, and that has a solids concentration of at least about 70% by weight, to a temperature of at least about 40° C.; and contacting the feed composition with at least one catalyst that accelerates the rate of cleavage or formation of glucosyl bonds for a time sufficient to cause formation of oligosaccharides comprising α(1→6), α(1→2), α(1→3), or beta glycosidic linkages, wherein a product composition is produced that contains a higher concentration of oligosaccharides comprising α(1→6), α(1→2), α(1→3), or beta glycosidic linkages than primarily α(1→4)-linked oligosaccharides; wherein the product composition comprises oligosaccharides comprising α(1→6), α(1→2), α(1→3), or beta glycosidic linkages having a degree of polymerization of at least three in a concentration of at least about 20% by weight on a dry solids basis.

Fructans are polymers of D-fructose units, often with a D-sucrose unit at their terminal ends. They can be obtained from chicory root or from enzymatic conversion of sucrose. The D-fructose units are typically linked by β(2→1) linkages, as in the case of inulin, by β(2→6) glycosidic linkages, as in the case of levan, or both, as in the case of graminin-type fructans. Short chain length fructans are called fructo-oligosaccharides (FOS). Inulins are a group of naturally occurring fructans.

Fructo-oligosaccharides (FOS) are classified as a soluble dietary fiber by US FDA. FOS exist naturally in more than 36,000 kinds of plants. FOS is recognized as an ideal prebiotic because of its significant health benefits, excellent processability and good taste. As a result, it has been used extensively in food industries. Suitable commercial FOS products for use in the present invention include EUOLIFO® FOS 1-Kestose (GF2), 6G-Kestose (6G-GF2), 6-Kestose (6-GF2), Nystose (GF3), 1F-Fructofuranosylnystose (GF4) and 1F-Fructofuranosyl-1F-Fructofuranosylnystose (GF5) 6 FOS monomer, inulobiose, inulotriose, inulotetraose, 1-6G-kestotetraose all available from Quantum Hi-Tech (Guangdong) Biological Co., Ltd. (Tate & Lyle), and NUTRAFLORA® FB P-95, P-95, and L95-S all available from Ingredion.

Galactooligosaccharides (GOS) are polymers of galactose that are prepared by beta-galactosidase-catalyzed polymerization of lactose. GOS are prebiotic soluble fibers that have been reported to contribute to weight loss when incorporated into the diet.

Galactomannans are polysaccharides consisting of a mannose backbone with galactose side groups (more specifically, a (1-4)-linked beta-D-mannopyranose backbone with branchpoints from their 6-positions linked to alpha-D-galactose, (i.e. 1-6-linked alpha-D-galactopyranose).

Galactomannans include fenugreek gum, guar gum, tara gum, locust bean gum, and cassia gum. Partially hydrolysed galactomannans have lower viscosity than galactomannans and are easier to incorporate into food.

In preferred embodiments, the soluble fiber comprises any selected from the group consisting of polydextrose, hydrogenated polydextrose, soluble corn fiber, fructans (including inulin and FOS), GOS, RD, galactomannans (including fenugreek gum, guar gum, tara gum, locust bean gum, and cassia gum), hydrolyzed galactomannans (including hydrolyzed fenugreek gum, hydrolyzed guar gum, hydrolyzed tara gum, hydrolyzed locust bean gum, and hydrolyzed cassia gum), and a combination of two or more of any of the foregoing. In preferred embodiments, the soluble fiber comprises any selected from the group consisting of: PDX, fructans (including inulin and FOS), GOS, HPDX, SCF, and a combination of two or more of any of the foregoing. In particularly preferred embodiments, the soluble fiber comprises of any selected from the group consisting of: PDX, inulin, SCF, and a combination of two or more of any of the foregoing.

Soluble fibers can have a variety of molecular weights (consistent with remaining substantially water-soluble). In certain embodiments, the fiber has a weight average molecular weight in the range of 500 g/mol to 10,000 g/mol. For example, in certain such embodiments, the soluble fiber has a weight average molecular weight in the range of 500 g/mol to 5,000 g/mol. In various additional embodiments, the soluble fiber has a weight average molecular weight in the range of 750 to 9,000 g/mol, or 1,000 g/mol to 8,000 g/mol, or 1,000 g/mol to 6,000 g/mol, or 1,200 to 5,000 g/mol, or 1,200 to 2,500 g/mol, or 2,500 g/mol to 5,000 g/mol, or 5,000 g/mol to 10,000 g/mol, or 500 g/mol to 2,000 g/mol. As used herein, molecular weight of soluble fibers are determined by gel permeation chromatography, using narrow standard pullulans as standards.

The soluble fiber may have a degree of polymerization of from about 3 to about 50, preferably from about 5 to about 40, more preferably from about 5 to about 30.

Commercially available soluble fiber-containing products for use in food manufacturing typically include monomers and dimers of their monomeric units. The proportions of the polymers, the monomers and dimers and moisture vary from product to product, but are typically 60% to 90% by weight of polymer, 1% to 25% by weight of monomers and dimers, and 1% to 35% by weight of moisture. Accordingly, when using any soluble fiber product, it is customary to determine the proportions of the polymer, monomers and dimers, and moisture present in the soluble fiber product and to use an appropriate amount of the soluble fiber product to provide the desired content of polymer, monomers and dimers and moisture. The content of polymer, monomers and dimers and moisture can be determined from the product label or manufacturer's specification or it can be determined experimentally by conventional means known in the art. For example, the fiber content of a soluble fiber product may be determined by AOAC 2001.03. In preferred embodiments, the soluble fiber is added as a product having a fiber content in the range of about 65% to about 100% by weight on a dry solids basis, preferably from about 67% to about 98% by weight on a dry solids basis. Preferably, the soluble fiber is added as a product having a monosaccharide, disaccharide or sugar alcohols content of less than about 20% by weight.

Gummies according to the present invention contain a soluble fiber in an amount of from about 40% to about 90% by weight on a dry solids basis. In preferred embodiments, the gummy comprises the soluble fiber in an amount of from about 44% to about 87%, from about 47% to about 85%, from about 50% to about 75%, from about 52% to about 70%, from about 55% to about 68%, from about 55% to about 60%, from about 60% to about 85%, from about 70% to about 85%, or from about 80% to about 85%, by weight on a dry solids basis.

It is also possible to define the soluble fiber content of the gummy of the invention by reference to the amount of soluble fiber to be delivered per serving. In some embodiments, the gummy includes at least about 2.5 g of soluble fiber per serving. For example, certain embodiments of gummies as described herein include at least about 3 g, at least about 4 g, at least about 5 g, at least about 6 g, at least about 8 g, at least about 10 g, at least about 20 g of soluble fiber per serving. In some embodiments, the gummy is provided as a nutritional supplement.

The weight of the serving can be, for example, from about 3 g to about 90 g, from about 5 g to about 50 g, or preferably from about 20 g to about 40 g. In some embodiments, an individual gummy can be from about 3 g to about 20 g, preferably from about 5 g to about 10 g. A serving can comprise for example from 1 to 30 gummies, 1 to 20 gummies, 1 to 10 gummies, or preferably 4 to 8 gummies. The number of gummies per serving depends on the weight of the serving and the weight of the individual gummies.

The soluble fiber may comprise one type of soluble fiber or it may comprise a combination of any two or more types of soluble fiber. For instance, the soluble fiber may comprise any of the types of soluble fibers described herein (PDX, SCF, HPDX, fructans, GOS, galactomannans, hydrolyzed galactomannans and subcategories thereof), together with any other soluble fiber. The soluble fiber may comprise of a combination of any two or more types of soluble fibers described herein. For instance, the soluble fiber is any one selected from the following combinations of soluble fibers:

PDX/HPDX, PDX/SCF, PDX/a fructan, PDX/FOS, PDX/FOS/GOS, PDX/GOS, PDX/inulin, PDX/RD, PDX/a galactomannan, PDX/a hydrolyzed galactomannan; HPDX/SCF, HPDX/a fructan, HPDX/FOS, HPDX/GOS, HPDX/inulin, HPDX/RD, HPDX/a galactomannan, HPDX/a hydrolyzed galactomannan; SCF/a fructan, SCF/FOS, SCF/GOS, SCF/inulin, SCF/RD, SCF/a galactomannan, SCF/a hydrolyzed galactomannan; inulin/FOS, inulin/GOS, inulin/RD, inulin/a galactomannan, inulin/a hydrolyzed galactomannan; FOS/GOS, FOS/a galactomannan, GOS/a hydrolyzed galactomannan, FOS/a galactomannan, GOS/a hydrolyzed galactomannan, RD/a galactomannan, RD/a hydrolyzed galactomannan; a galactomannan/a hydrolyzed galactomannan, PDX/HPDX/SCF, PDX/a fructan/SCF, PDX/FOS/SCF, PDX/GOS/SCF, PDX/inulin/SCF, PDX/RD/SCF, PDX/a galactomannan/SCF, PDX/a hydrolyzed galactomannan/SCF; HPDX/a fructan/SCF, HPDX/FOS/SCF, HPDX/GOS/SCF, HPDX/inulin/SCF, HPDX/RD/SCF, HPDX/a galactomannan/SCF, HPDX/a hydrolyzed galactomannan/SCF; inulin/FOS/SCF, inulin/GOS/SCF, inulin/RD/SCF, inulin/a galactomannan/SCF, inulin/a hydrolyzed galactomannan/SCF; FOS/a galactomannan/SCF, GOS/a galactomannan/SCF, RD/a galactomannan/SCF, RD/a hydrolyzed galactomannan/SCF; a galactomannan/a hydrolyzed galactomannan/SCF, HPDX/a fructan/PDX, HPDX/FOS/PDX, HPDX/GOS/PDX, HPDX/inulin/PDX, HPDX/RD/PDX, HPDX/a galactomannan/PDX, HPDX/a hydrolyzed galactomannan/PDX; inulin/FOS/PDX, inulin/GOS/PDX, inulin/RD/PDX, inulin/a galactomannan/PDX, inulin/a hydrolyzed galactomannan/PDX; GOS/a galactomannan/PDX, FOS/a galactomannan/PDX, GOS/a galactomannan/PDX, FOS/a hydrolyzed galactomannan/PDX, RD/a galactomannan/PDX, RD/a hydrolyzed galactomannan/PDX; a galactomannan/a hydrolyzed galactomannan/PDX, HPDX/FOS, GOS/SCF/FOS, GOS/inulin/FOS, GOS/FOS/a galactomannan, GOS/FOS/a galactomannan, GOS/PDX/FOS/SCF, GOS/HPDX/FOS/SCF, GOS/inulin/FOS/SCF, GOS/FOS/a galactomannan/SCF, GOS/HPDX/FOS/PDX, GOS/inulin/FOS/PDX, GOS/FOS/a galactomannan/PDX, GOS/FOS/a galactomannan/PDX. In preferred embodiments, the soluble fiber is one, two or three of PDX, SCF, FOS, inulin, and GOS.

In preferred embodiments, the soluble fiber is SCF, FOS or a combination of SCF and FOS. In particularly preferred embodiments, the soluble fiber is SCF, FOS or a combination of SCF and FOS and is present in the gummy in an amount of from about 60% to about 80% by weight on a dry solids basis, preferably from about 55% to 75% by weight on a dry solids basis. In particularly preferred embodiments, the soluble fiber is FOS.

A combination of GOS/FOS containing is 100-900 parts GOS and 100-900 parts FOS may suitably be used.

### Gelling Agent

Gelling agents are required for setting the gummies of the present invention.

In the aspects of the present invention, any gelling agent may be used. Examples of gelling agents that may be used in the present invention are gelatin, alginic acid and salts thereof, carrageenan, locust bean gum, curdlan, pectin or any combination of the foregoing. In preferred embodiments, the gelling agent is gelatin.

The gelling agent is used the gummy in an amount of from about 1% to about 25% by weight on a dry solids basis. In preferred embodiments, the gelling agent is used in the gummy an amount of from about 3% to about 25%, from about 4% to about 20%, from about 5% to about 15%, from about 6% to about 12%, or from about 8% to about 12%, by weight on a dry solids basis.

In preferred embodiments, the gelling agent is gelatin or pectin. In particularly preferred embodiments, the gelling agent is gelatin and is used in the gummy in an amount of from about 8% to about 12%, by weight on a dry solids basis. In other particularly preferred embodiments, the gelling agent is pectin and is used in the gummy in an amount of from about 1% to about 5% by weight on a dry solids basis, such as 1% to 3%.

### Low-Molecular Weight Saccharide or Sugar Alcohol

In the aspects of the present invention, the gummies comprise a low-molecular weight saccharide or sugar alcohol in an amount of from about 1% to about 45% by weight on a dry solids basis.

In preferred embodiments, the gummy comprises the low-molecular weight saccharide or sugar alcohol in an amount of from about 1.5% to about 42%, from about 2% to about 40%, from about 3% to about 36%, from about 5% to about 35%, from about 7% to about 30%, from about 8% to about 22%, from about 9% to about 20%, or from about 10% to about 18% by weight on a dry solids basis.

As noted above, soluble fibers are polymer compositions that typically comprise low-molecular weight saccharide or sugar alcohols. Accordingly, when soluble fiber is added to the gummy, it is expected that some low-molecular weight saccharide or sugar alcohols will also be added to the gummy. These low-molecular weight saccharide or sugar alcohols count towards the low-molecular weight saccharide or sugar alcohol weight and not to the soluble fiber.

For example, when adding SCF, PDX or RD to the gummy, it is expected that some glucose, maltose and isomaltose will be introduced. When adding HPDX to the gummy, it is expected that some sorbitol will be introduced. When adding a fructan (FOS or inulin) to the gummy, it is expected that some fructose or fructose disaccharides will be added. When adding GOS, galactomannans or hydrolyzed galactomannans to the gummy, it is expected that some galactose and galactose disaccharides will be introduced. Each of the monosaccharides, disaccharides and sugar alcohols mentioned in this paragraph may be present in the soluble fiber ingredient in an amount of up to 25% by weight on a dry solids basis, e.g., up to 20%. In certain embodiments, a soluble fiber as otherwise described herein can have a relatively lower amount of monosaccharides, disaccharides and sugar alcohols, e.g., no more than 15% or no more than 10% by weight on a dry solids basis. In some embodiments, the soluble dietary fiber has no more than 2% by weight on a dry solids basis total mono- and disaccharides, or even no more than 1%. In certain embodiments, there is a relatively significant amount of monosaccharides, disaccharides and sugar alcohols in the soluble dietary fiber. For example, in certain embodiments as otherwise described herein, the total amount of monosaccharides, disaccharides and sugar alcohols is in the range of 5% to 25% by weight on a dry solids basis. For example, the total amount of monosaccharides, disaccharides and sugar alcohols may be in the range of 10% to 20%, or 15% to 25% by weight on a dry solids basis.

As used herein, low-molecular weight sugars or sugar alcohols means all monosaccharides, disaccharides, sugar alcohols, and conjugates of sugar alcohols and monosaccharides, that have up to 12 carbon atoms. However, in some embodiments, the gummies are substantially free of sucrose, in which case low-molecular weight sugars or sugar alcohols means all monosaccharides, disaccharides, sugar alcohols, and conjugates of sugar alcohols and monosaccharides, that have up to 12 carbon atoms, except sucrose.

As noted above, the gummy is preferably substantially free of sucrose. The gummy is preferably substantially free of maltodextrin. The gummy is preferably substantially free of sucrose and maltodextrin. As used herein, substantially free of sucrose and substantially free of maltodextrin mean that the gummy contains no more than 1% by weight, preferably no more than 0.5% or 0.1% or 0.01% by weight on a dry solids basis of the material.

The gummy is preferably substantially free of glucose. As used herein, substantially free of glucose means that no free glucose is added to the recipe. It is appreciated that soluble fibers such as SCF, PDX, and RD may contain monomer fractions. As used herein, gummies that are substantially free of glucose may contain small quantities of glucose which are added as the monomer fraction of a soluble fiber. The glucose content of the gummies is preferably 10% or less, more preferably 5% or less, more preferably 1% or less by weight and more preferably 0.5% or less by weight on a dry solids basis.

The gummy is preferably substantially free of fructose. As used herein, substantially free of fructose means that no free fructose is added to the recipe. It is appreciated that soluble fibers such as FOS and inulin may contain monomer fractions. As used herein, gummies that are substantially free of fructose may contain small quantities of glucose which are added as the monomer fraction of a soluble fiber. The fructose content of the gummies is preferably 10% or less, more preferably 5% or less, more preferably 1% or less by weight and more preferably 0.5% or less by weight on a dry solids basis.

The gummy is preferably substantially free of maltose. As used herein, substantially free of maltose means that no free maltose is added to the recipe. It is appreciated that soluble fibers such as SCF, PDX, and RD may contain dimer fractions. As used herein, gummies that are substantially free of maltose may contain small quantities of maltose which are added as the dimer fraction of a soluble fiber. The maltose content of the gummies is preferably 10% or less, more preferably 5% or less, more preferably 1% or less by weight and more preferably 0.5% or less by weight on a dry solids basis.

The low-molecular weight saccharide or sugar alcohol may comprise or consist of any selected from the group consisting of a monosaccharide, a disaccharide, a sugar alcohol, a conjugate of a sugar alcohol and a monosaccharide, and a combination of any two or more of the foregoing. In preferred embodiments, the low-molecular weight saccharide or sugar alcohol comprises or consists of any selected from the group consisting of: allose, altrose, galactose, galactose disaccharides, dextrose, dextrose disaccharides (e.g. maltose, isomaltose), gulose, idose, mannose, talose, fructose, fructose disaccharides, allulose, sorbose, tagatose, fucose, fuculose, rhamnose, arabitol, erythritol, glycerol, isomalt, lactitol, maltitol, mannitol, sorbitol, xylitol, and a combination of two or more of any of the foregoing. In preferred embodiments, the low-molecular weight saccharide or sugar alcohol comprises or consists of any selected from the group consisting of: dextrose, dextrose disaccharides (e.g. maltose, isomaltose), fructose, allulose, tagatose, erythritol, maltitol, sorbitol, xylitol, and a combination of two or more of any of the foregoing.

In particularly preferred embodiments, the low-molecular weight saccharide or sugar alcohol comprises or consists of any selected from the group consisting of: dextrose, dextrose disaccharides (e.g. maltose, isomaltose), fructose, fructose disaccharides, allulose, tagatose, erythritol, maltitol, sorbitol, xylitol, and a combination of two or more of any of the foregoing.

Allulose can be added as DOLCIA PRIMA® Crystalline Allulose or DOLCIA PRIMA® Allulose Syrups available from Tate & Lyle.

In some embodiments, the low-molecular weight saccharide or sugar alcohol comprises allulose in an amount sufficient to provide an allulose content in the gummy of from about 1% to about 20%, from about 1% to about 15%, from about 2% to about 10%, or from about 3% to about 5% by weight on a dry solids basis. In some embodiments, the low-molecular weight saccharide or sugar alcohol comprises sorbitol in an amount sufficient to provide a sorbitol content in the gummy of from about 1% to about 20%, from about 1% to about 15%, from about 2% to about 10%, or from about 3% to about 5% by weight on a dry solids basis. In some embodiments, the low-molecular weight saccharide or sugar alcohol comprises erythritol in an amount sufficient to provide an erythritol content in the gummy of from about 1% to about 20%, from about 1% to about 15%, from about 2% to about 10%, or from about 3% to about 5% by weight on a dry solids basis. In some embodiments, the low-molecular weight saccharide or sugar alcohol comprises maltitol in an amount sufficient to provide a maltitol content in the gummy of from about 1% to about 20%, from about 1% to about 15%, from about 2% to about 10%, or from about 3% to about 5% by weight on a dry solids basis. In some embodiments, the low-molecular weight saccharide or sugar alcohol comprises xylitol in an amount sufficient to provide a xylitol content in the gummy of from about 1% to about 20%, from about 1% to about 15%, from about 2% to about 10%, or from about 3% to about 5% by weight on a dry solids basis.

In preferred embodiments, the gummy comprises allulose in an amount of from about 10% to about 45% by weight on a dry solids basis, preferably from about 20% to about 35% by weight on a dry solids basis.

### Water and Total Dry Solids Content

The gummies of the present invention are a hydrocolloid gel of soluble fiber, low-molecular saccharides and a gelling agent in water.

In aspects of the present invention, the gummy has a total dry solids content of from about 75% to about 90% by weight and a moisture content of about 10% to about 25% by weight. In preferred embodiments, the gummy has a total dry solids content of from about 75% to about 88%, from about 77% to about 86% by weight, from about 79% to about 85% by weight, preferably from about 80% to about 84% by weight or from about 80% to about 82% by weight. In these cases, the gummy respectively has a moisture content of from about 12% to about 25% by weight, from about 14% to about 23% by weight, from about 15% to about 21% by weight, from about 16% to about 20% by weight, or from about 18% to about 20% by weight.

Moisture is introduced into the gummies from multiple sources. Moisture may be introduced with the soluble fiber product, gelling agent or low molecular weight saccharides or sugar alcohols products, which can be syrups or hygroscopic solids and therefore have their own moisture content. Additional water is added during the manufacturing process to dissolve and mix the ingredients. The final moisture/dry solids content of the gummies is influenced by the amount of moisture added by the foregoing, but it is primarily driven by the drying temperature and time. The drying temperature and time can be adjusted to achieve a target dry solids concentration.

Total dry solids content of the gummy can be measured by refractive analysis of the gummy. Alternatively, the total dry solids content can be determined by comparing the weight of the dry solids added to the gummy and weighing the final gummy. The total dry solids content of the gummy is the ratio of the total dry solids added to the gummy to the total weight of the gummy, expressed as a percentage.

### Gummies

Preferred examples of gummies according to the invention will now be described.

The gummy preferably comprises:
a soluble fiber in an amount of from about 50% to about 85% by weight on a dry solids basis;
the gelling agent in an amount of from about 8% to about 12% by weight on a dry solids basis;
a low-molecular weight saccharide or sugar alcohol in an amount of from about 18% to about 42% by weight on a dry solids basis; and
wherein the gummy has a total dry solids content of from about 80% to about 84%.

In the foregoing, the gummy preferably comprises the soluble fiber in an amount of from about 50% to about 80% by weight on a dry solids basis. The soluble fiber is preferably: PDX, SCF, inulin, FOS, PDX/SCF, PDX/inulin, SCF/inulin, PDF/FOS, SCF/FOS, PDX/SCF/FOS or PDX/SCF/inulin.

In the foregoing, the gelling agent is preferably gelatin.

It is particularly preferred that:
the soluble fiber is SCF, FOS or a combination of SCF and FOS and is present in the gummy in an amount of from about 60% to about 80% by weight on a dry solids basis, preferably from about 55% to 75% by weight on a dry solids basis;
the low-molecular weight saccharide or sugar alcohol is allulose and is present in an amount of from about 10% to about 45% by weight on a dry solids basis, preferably from about 20% to about 35% by weight on a dry solids basis.

When the gummy comprises SCF, FOS or a combination of SCF and FOS and allulose in these amounts alone or in combination with other low-molecular weight saccharides or sugar alcohols, the cooking viscosity is lower and it is easier to deposit the slurry into molds at high solids content. FOS and allulose-containing gummies also exhibit excellent sugar-like sweetness and texture (pectin set, softness and clarity).

It other embodiments, the gummy preferably comprises fructo-oligosaccharides (FOS) in an amount of from about 40% to about 99% by weight on a dry solids basis; a gelling agent in an amount of from about 1% to about 25% by weight on a dry solids basis; and water; wherein the gummy has a total dry solids content of from about 75% to about 90%. The gummy may or may not include a low-molecular weight saccharide or sugar alcohol. The gelling agent is preferably pectin. The gelling agent is preferably present in an amount of from about 1% to about 5%, preferably 1% to 4%, more preferably 1% to 3%, more preferably 2% to 3% by weight on a dry solids basis. The FOS is preferably present in an amount of from about 70% to about 99% by weight on a dry solids basis. All other qualities of the gummy, such as quantities of soluble fiber, low-molecular weight saccharide or sugar alcohol, water, additional ingredients may be as described anywhere herein.

In the foregoing, the gummy preferably comprises the low-molecular weight saccharide or sugar alcohol in an amount of from about 8% to about 32% by weight on a dry solids basis. The low-molecular weight saccharide or sugar alcohol preferably comprises allulose, tagatose, erythritol, maltitol, sorbitol, and/or xylitol. The low-molecular weight saccharide or sugar alcohol preferably comprises or consists of dextrose, dextrose disaccharides (e.g. maltose, isomaltose), fructose, fructose disaccharides allulose, tagatose, galactose, galactose disaccharides, erythritol, maltitol, sorbitol, and/or xylitol. The low-molecular weight saccharide or sugar alcohol is preferably dextrose/maltose/isomaltose/allulose, dextrose/maltose/isomaltose/tagatose, fructose/allulose, dextrose/maltose/isomaltose/xylitol, dextrose/maltose/isomaltose/sorbitol, fructose/xylitol, dextrose/maltose/isomaltose/mannitol, dextrose/maltose/isomaltose/maltitol, fructose/mannitol, dextrose/maltose/isomaltose/erythritol, fructose/sorbitol, fructose/erythritol, fructose/dextrose/maltose/isomaltose/allulose, fructose/dextrose/maltose/isomaltose/xylitol, fructose/maltitol, fructose/dextrose/maltose/isomaltose/tagatose, fructose/tagatose, fructose/dextrose/maltose/isomaltose/sorbitol, fructose/dextrose/maltose/isomaltose/mannitol, fructose/dextrose/maltose/isomaltose/maltitol, fructose/dextrose/maltose/isomaltose/erythritol, fructose/tagatose. The low-molecular weight saccharide or sugar alcohol is preferably one or two of allulose, tagatose, xylitol, sorbitol, mannitol, erythritol or maltitol in an amount sufficient to provide to provide a content of each of those one or two components in the gummy of from about from about 2% to about 10%, or from about 3% to about 5% by weight on a dry solids basis. The low-molecular weight saccharide or sugar alcohol is most preferably allulose.

In some embodiments, the gummy consists essentially of:
the soluble fiber;
the gelling agent;
the low-molecular weight saccharide or sugar alcohol comprises which is any selected from the group consisting of: allose, altrose, galactose, galactose disaccharides, dextrose, dextrose disaccharides (e.g. maltose, isomaltose), gulose, idose, mannose, talose, fructose, fructose disaccharides, allulose, sorbose, tagatose, fucose, fuculose, rhamnose, arabitol, erythritol, glycerol, isomalt, lactitol, maltitol, mannitol, sorbitol, xylitol, and a combination of two or more of any of the foregoing;
water; and
   optionally one or more additional ingredients in an aggregate amount of up to 2% by weight on a dry solids basis.

A gummy consisting essentially of these ingredients contains no more than 1% by weight, preferably no more than 0.5% or 0.1% or 0.01% by weight on a dry solids basis of other ingredients. In other words, the gummy contains at least 99%, preferably at least 99.5%, 99.9% or 99.99% of the soluble fiber, gelling agent, low-molecular weight saccharide or sugar alcohol water and optional additional ingredients described below.

### Additional Ingredients

The gummies of the present invention optionally include one or more additional ingredients. The additional ingredient can be ingredient suitable for consumption and can be present in any amount desired to provide a gummy with the desired composition or characteristics.

The one or more additional ingredients may be present in an aggregate amount of up to 2% by weight on a dry solids basis, for example up to 1% or between 1% and 2% by weight.

In some embodiments, the one or more additional ingredients comprise one or more natural and/or synthetic high intensity sweeteners. The one or more natural and/or synthetic high intensity sweeteners can be selected from the group consisting of stevia extract, monk fruit extract, brazzein, thaumatin, monellin, monatin and its salts, glycyrrhizic acid and its salts, sucralose, aspartame and acesulfame potassium.

When present, the gummy may comprise the stevia extract in an amount of from about 0.01% to about 0.2% by weight dry solids basis. The stevia extract comprises at least one steviol glycoside. The at least one steviol glycoside may be selected from the group consisting of Rebaudioside A, Rebaudioside B, Rebaudioside C, Rebaudioside D, Rebaudioside E, Rebaudioside F, Rebaudioside M, Rebaudioside X, Rubusoside, Stevioside and Dulcosides, and mixtures thereof. According to a preferred embodiment, the at least one steviol glycoside comprises Rebaudioside A and/or Rebaudioside B. Preferably, the at least one steviol glycoside comprises both Rebaudioside A and Rebaudioside B. Preferably, the stevia extract comprises Rebaudioside A in an amount of from about 60 weight % to about 85 weight %, preferably from about 70 weight % to about 85 weight %, and more preferably from about 75 weight % to about 80 weight %, relative to the combined total weight of steviol glycosides in the stevia extract on a dry solids basis. In some embodiments, the stevia extract comprises Rebaudioside A in an amount of from about 60 weight % to about 80 weight %, preferably from about 67 weight % to about 73 weight %, relative to the combined total weight of steviol glycosides in the stevia extract on a dry solids basis. For example, the stevia extract may comprise Rebaudioside A in an amount of 60, 61, 62, 63, 64, 65, 66, 67, 68, 69, 70, 71, 72, 73, 74, 75, 76, 77, 78, 79, 80, 81, 82, 83, 84 or 85 weight %, relative to the combined total weight of steviol glycosides in the stevia extract on a dry solids basis. According to a preferred embodiment, the stevia extract comprises Rebaudioside B in an amount of from about 15 weight % to about 30 weight %, preferably from about 19 weight % to about 23 weight %, relative to the combined total weight of steviol glycosides in the stevia extract on a dry solids basis. For example, the stevia extract may comprise Rebaudioside B in an amount of 15, 16, 17, 18, 19, 20, 21, 22, 23, 24, 25, 26, 27, 28, 29 or 30 weight %, relative to the combined total weight of steviol glycosides in the stevia extract on a dry solids basis. In an embodiment, the stevia extract comprises Rebaudioside A and Stevioside in a combined total amount of at least 70 weight %, preferably in a combined total amount of 75 weight % or more, relative to the total weight of the stevia extract on a dry solids basis. The stevia extract preferably comprises Rebaudioside D in an amount of up to 10 weight % relative to the combined total weight of steviol glycosides in the stevia extract on a dry solids basis. The stevia extract preferably comprises Rebaudioside M in an amount of up to 5 weight % relative to the combined total weight of steviol glycosides in the stevia extract on a dry solids basis.

The one or more additional ingredients may comprise one or more of any selected from the group consisting of: bulking agents; fats; oils; milk and/or other dairy products; alcohol; gums; natural and/or synthetic colorants; natural and/or synthetic flavorants; salt; spices; fruits and fruit-derived products; vegetables and vegetable-derived products; legumes and legume-derived products; nuts and nut-derived products; preservatives; stabilizers; antioxidants; emulsifiers; proteins; amino acids; and acidulants, such as acetic acid, citric acid, phosphoric acid, lactic acid, malic acid, fumaric acid, ascorbic acid, tartaric acid and hydrochloric acid.

In particularly preferred embodiments, the one or more additional ingredients comprise one or more nutraceuticals selected from the group consisting of:
vitamins, such as Vitamin A, Vitamin C, Vitamin D, Vitamin E, Vitamin K, Vitamin B1 (thiamine), Vitamin B2 (riboflavin), Vitamin B3 (niacin), Vitamin B6 (pyridoxine), Vitamin B12 (cyanocobalamin), Pantothenic acid (B5), Biotin (B7), Folate (folic acid or B9);
minerals, such as nutritionally acceptable compounds of calcium, phosphorus, potassium, sodium, chloride, magnesium, iron, zinc, iodine, sulfur, cobalt, copper, fluoride, manganese, and selenium; and
bioactive compounds, such as polyphenols, carotenoids, vitamins, omega-3 fatty acids, organic acids, nucleosides and nucleotides, and phytosterols, in particular lycopene, resveratrol, lignan, and tannins.

The gummy preferably comprises the one or more nutraceuticals in an amount suitable to deliver about 10%, about 11%, about 12.5%, about 14%, about 20%, about 25%, about 33%, about 50%, about 75%, or about 100% of the daily value of the one or more nutraceuticals per gummy. In such embodiments, the total daily value may be supplied respectively by consuming 10, 9, 8 7, 6, 5, 4, 3, 2 or 1 gummies. The daily value according to FDA are listed below.

| Nutrient | Daily Value | | Nutrient | Daily Value | |
|---|---|---|---|---|---|
| Calcium | 1300 | mg | Niacin | 16 | mg NE |
| Magnesium | 420 | mg | Pantothenic | 5 | mg |
| | | | Acid | | |
| Manganese | 2.3 | mg | Riboflavin | 1.3 | mg |
| Phosphorus | 1250 | mg | Selenium | 55 | mcg |
| Potassium | 4700 | mg | Sodium | 2300 | mg |
| Vitamin C | 90 | mg | Thiamin | 1.2 | mg |
| Vitamin D | 20 | mcg | Vitamin A | 900 | mcg RAE |
| Vitamin K | 120 | mcg | Vitamin B6 | 1.7 | mg |
| Biotin | 30 | mcg | Vitamin B12 | 2.4 | mcg |
| Chloride | 2300 | mg | Vitamin E | 15 mg | |
| | | | | alpha-tocopherol | |
| Chromium | 35 | mcg | Zinc | 11 | mg |
| Copper | 0.9 | mg | Iodine | 150 | mcg |
| Folate/Folic | 400 | mcg DFE | Iron | 18 | mg |
| Acid | | | | | |
| Choline | 550 | mg | | | |

g = grams
mg = milligrams
mcg = micrograms
mg NE = milligrams of niacin equivalents
mcg DFE = micrograms of dietary folate equivalents
mcg RAE = micrograms of retinol activity equivalents

### Method of Preparing Gummies

Gummies according to the invention may be prepared by any suitable method for preparing gummies having the required composition.

In one aspect, a process for preparing a gummy comprises the steps of:
a) dispersing a soluble fiber; one or more low-molecular weight saccharides, sugar alcohols, or a combination thereof; a gelling agent in water to provide a gelling composition having:
soluble fiber in an amount of from about 40% to about 90% by weight on a dry solids basis;
a gelling agent in an amount of from about 1% to about 25% by weight on a dry solids basis;
a low-molecular weight saccharide or sugar alcohol in an amount of from about 1% to about 45% by weight on a dry solids basis; and
b) drying the gelling composition to provide a gummy having a total dry solids content of from about 75% to about 90%.

In another aspect, a process for preparing a gummy comprises the steps of:
a) dispersing FOS and a gelling agent in water to provide a gelling composition having:
FOS in an amount of from about 40% to about 99% by weight on a dry solids basis;
a gelling agent in an amount of from about 1% to about 25% by weight on a dry solids basis; and
b) drying the gelling composition to provide a gummy having a total dry solids content of from about 75% to about 90%. A low-molecular weight saccharide or sugar alcohol may also be added in step a) to give a gelling composition having a low-molecular weight saccharide or sugar alcohol in an amount of from about 1% to about 45% by weight on a dry solids basis.

In some embodiments, step (a) of the process comprises one or more of the following steps:
a1) dispersing the soluble fiber and the monosaccharide or the sugar alcohol in water to provide a bulk ingredient slurry;
a2) dissolving the gelling agent in water to provide a gelling agent slurry;
   a2′) optionally wherein the gelling agent slurry has a ratio of gelling agent to water of from about 1:1 to about 1:2, preferably about 1:1.5;
a3) heating the bulk ingredients slurry to provide a saccharide syrup;
   a3′) optionally wherein the bulk ingredients slurry is heated to 225° F. to 235° F. (107.2° C. to 112.8° C.) to provide the saccharide syrup syrup having a total dry solids content of 80% to 82%;
a4) heating the gelling agent slurry to provide a heated gelling agent slurry;
   a4′) optionally heating the gelling agent slurry to 150° F. to 200° F., preferably 165° F. to 175° F. (73.9° C. to 79.4° C.), to provide the heated gelling agent slurry;
a5) adding the heated gelling agent slurry to the saccharide syrup to provide the gelling composition;
a5′) optionally agitating the gelling composition without aeration;
a6) heating the gelling composition to 150° F. to 200° F. (65.6° C. to 93.3° C.);
   a6′) optionally agitating the gelling composition without aeration;
   a6″) optionally heating the gelling composition to 175° F. to 185° F. (79.4° C. to 85.0° C.).

In some embodiments, step (b) of the process comprises one or more of the following steps:
b1) transferring the gelling composition to a mold;
b2) drying the gelling composition to provide the gummy having a total dry solids content of from about 75% to about 90%;
   b2′) optionally stoving the gummy forming composition at about 85° F. (29.4° C.).

In some embodiments, the process comprises the step of:
c) coating the gummy
   c′) optionally coating the gummy with a glaze selected from the group consisting of: vegetable oils or animal fats and waxes such as beeswax, shellac, candelilla wax, microcrystalline wax and carnauba wax.

### EXAMPLES

### Examples 1 to 16—Preparation of Gummies

Gummies were prepared with the compositions described in Table 1. For each example in Table 1, the first column (Gross (g)) indicates the gross weight in grams of the ingredient as included in the recipe, the middle column (Dry (g)) indicates the net (dry) in grams of the ingredient as included in the recipe, and the final column (% DS) indicates the total dry solids content by weight of the ingredient in the final, unglazed gummies.

A gelling agent slurry was prepared by hydrating the gelatin in 1.5 times its gross weight of water and heating the gelling agent slurry to 165° F. (74.9° C.) to 170° F. (76.7° C.). The gelling agent slurry was maintained at 165° F. (74.9° C.) to 170° F. (76.7° C.) after complete hydration. The low-molecular weight saccharide or sugar alcohol ingredient and the soluble fiber ingredient were dispersed in water in a ratio of approximately 3 parts by weight total ingredients to 1 part by weight water with vigorous agitation and heating until all ingredients were completely solubilized to provide a carbohydrate syrup free of hydrated clumps. The carbohydrate syrup was cooked to approximately 235° F. (112.8° C.) until the slurry had a total dry solids content of approximately 84% by weight. The carbohydrate solution was cooled to 185° F. (85.0° C.). The gelling agent slurry was added slowly to the carbohydrate syrup to provide a gelling composition. The gelling composition was mixed gently and heated to 175° F. (79.4° C.) to 185° F. (85.0° C.). 500 g of the gelling composition was weighed out and any minor ingredients such as colorants were added. The gelling composition was deposited in starch molds and dried at 85° F. (29.4° C.) for 24 to 48 hours until the gummies had a final total dry solids content of 80 to 82%. The gummies were removed from the starch molds and polished with a glazing agent.

TABLE 1
Composition of gummies

| | | | |
|---|---|---|---|
| Example 1 | Example 2 | Example 3 | Example 4 |

| | | Gross | Dry | % | Gross | Dry | % | Gross | Dry | % | Gross | Dry | % |
|---|---|---|---|---|---|---|---|---|---|---|---|---|---|
| Table 1 | | (g) | (g) | DS | (g) | (g) | DS | (g) | (g) | DS | (g) | (g) | DS |
| Gelling | Gelatin | 40.00 | 36.80 | 9.55 | 40.00 | 36.80 | 9.55 | 40.00 | 36.80 | 9.55 | 160.00 | 147.20 | 10.31 |
| agent | | | | | | | | | | | | | |
| Soluble | SCF 1 | | | | 427.80 | 333.68 | 86.56 | 427.80 | 333.68 | 86.56 | | | |
| fiber | SCF 2 | | | | | | | | | | 1731.00 | 1220.18 | 85.48 |
| | PDX 1 | 355.00 | 333.70 | 86.56 | | | | | | | | | |
| Mono- | Xylitol | | | | 15.00 | 15.00 | 3.89 | | | | | | |
| saccharide | Allulose | 15.00 | 15.00 | 3.89 | | | | 15.00 | 15.00 | 3.89 | 60.00 | 60.00 | 4.20 |
| or sugar | | | | | | | | | | | | | |
| alcohol | | | | | | | | | | | | | |

| | | | | | | | | | | | | |
|---|---|---|---|---|---|---|---|---|---|---|---|---|
| Total | 410.00 | 385.50 | 100.00 | 482.80 | 385.48 | 100.00 | 482.80 | 385.48 | 100.00 | 1951.00 | 1427.38 | 100.00 |

| | | | |
|---|---|---|---|
| Example 5 | Example 6 | Example 7 | Example 8 |

| | | Gross | Dry | % | Gross | Dry | % | Gross | Dry | % | Gross | Dry | % |
|---|---|---|---|---|---|---|---|---|---|---|---|---|---|
| | | (g) | (g) | DS | (g) | (g) | DS | (g) | (g) | DS | (g) | (g) | DS |
| Gelling | Gelatin | 160.00 | 147.20 | 10.31 | 160.00 | 147.20 | 10.31 | 160.00 | 147.20 | 10.31 | 160.00 | 147.20 | 10.31 |
| agent | | | | | | | | | | | | | |
| Soluble | SCF 3 | 1740.40 | 1220.02 | 85.48 | | | | | | | | | |
| fiber | SCF 4 | | | | 1686.80 | 1220.06 | 85.48 | | | | | | |
| product | SCF 5 | | | | | | | 1740.40 | 1220.02 | 85.48 | | | |
| | SCF 6 | | | | | | | | | | 1727.80 | 1220.00 | 85.48 |
| Mono- | Allulose | 60.00 | 60.00 | 4.20 | 60.00 | 60.00 | 4.20 | 60.00 | 60.00 | 4.20 | 60.00 | 60.00 | 4.20 |
| saccharide | | | | | | | | | | | | | |
| or sugar | | | | | | | | | | | | | |
| alcohol | | | | | | | | | | | | | |

| | | | | | | | | | | | | |
|---|---|---|---|---|---|---|---|---|---|---|---|---|
| Total | 1960.40 | 1427.22 | 100.00 | 1906.80 | 1427.26 | 100.00 | 1960.40 | 1427.22 | 100.00 | 1947.80 | 1427.20 | 100.00 |

| | | | |
|---|---|---|---|
| Example 9 | Example 10 | Example 11 | Example 12 |

| | | Gross | Dry | % | Gross | Dry | % | Gross | Dry | % | Gross | Dry | % |
|---|---|---|---|---|---|---|---|---|---|---|---|---|---|
| | | (g) | (g) | DS | (g) | (g) | DS | (g) | (g) | DS | (g) | (g) | DS |
| Gelling | Gelatin | 160.00 | 147.20 | 10.31 | 160.00 | 147.20 | 10.31 | 160.00 | 147.20 | 10.31 | 160.00 | 147.20 | 10.31 |
| agent | | | | | | | | | | | | | |
| Soluble | SCF 7 | | | | | | | 1748.60 | 1220.00 | 85.48 | | | |
| fiber | PDX 2 | 1720.60 | 1220.08 | 85.48 | | | | | | | | | |
| | PDX 1 | | | | 1735.00 | 1220.05 | 85.48 | | | | | | |
| | FOS | | | | | | | | | | 1705.40 | 1220.04 | 85.48 |
| Mono- | Allulose | 60.00 | 60.00 | 4.20 | 60.00 | 60.00 | 4.20 | 60.00 | 60.00 | 4.20 | 60.00 | 60.00 | 4.20 |
| saccharide | Allulose | | | | | | | | | | | | |
| or sugar | | | | | | | | | | | | | |
| alcohol | | | | | | | | | | | | | |

| | | | | | | | | | | | | |
|---|---|---|---|---|---|---|---|---|---|---|---|---|
| Total | 1940.60 | 1427.28 | 100.00 | 1955.00 | 1427.25 | 100.00 | 1968.60 | 1427.20 | 100.00 | 1925.40 | 1427.24 | 100.00 |

| | | Example 13 | | | Example 14 | | | Example 15 | | | Example 16 | | |
|---|---|---|---|---|---|---|---|---|---|---|---|---|---|
| | | Gross | Dry | % | Gross | Dry | % | Gross | Dry | % | Gross | Dry | % |
| | | (g) | (g) | DS | (g) | (g) | DS | (g) | (g) | DS | (g) | (g) | DS |
| Gelling | Gelatin | 40.00 | 36.80 | 9.55 | 40.00 | 36.80 | 9.55 | 40.00 | 36.80 | 9.55 | 40.00 | 36.80 | 9.55 |
| agent | | | | | | | | | | | | | |
| Soluble | SCF 1 | 427.80 | 333.68 | 86.57 | | | | | | | | | |
| fiber | PDX 2 | | | | 355.00 | 333.70 | 86.56 | 355.00 | 333.70 | 86.56 | 355.00 | 333.70 | 86.56 |
| Mono- | Sorbitol | | | | 15.00 | 15.00 | 3.89 | | | | | | |
| saccharide | Erythritol | | | | | | | 15.00 | 15.00 | 3.89 | | | |
| or sugar | Maltitol | | | | | | | | | | 15.00 | 15.00 | 3.89 |
| alcohol | Allulose | 21.10 | 14.98 | 3.89 | | | | | | | | | |

| Total | | 488.90 | 385.47 | 100.00 | 410.00 | 385.50 | 100.00 | 410.00 | 385.50 | 100.00 | 410.00 | 385.50 | 100.00 |
|---|---|---|---|---|---|---|---|---|---|---|---|---|---|
| | | Example 17 | | | Example 18 | | | Comparative Example 1 | | | Comparative Example 2 | | |
| | | Gross | Dry | % | Gross | Dry | % | Gross | Dry | % | Gross | Dry | % |
| | | (g) | (g) | DS | (g) | (g) | DS | (g) | (g) | DS | (g) | (g) | DS |
| Gelling | Gelatin | 40.00 | 36.80 | 9.55 | 40.00 | 36.80 | 9.55 | 40.00 | 36.80 | 9.55 | 40.00 | 36.80 | 9.55 |
| agent | | | | | | | | | | | | | |
| Soluble | SCF 1 | 427.80 | 333.68 | 86.56 | | | | | | | 427.80 | 333.68 | 86.56 |
| fiber | PDX 2 | | | | | | | 355.00 | 333.70 | 86.56 | | | |
| | PDX 1 | | | | 355.00 | 333.70 | 86.56 | | | | | | |
| Mono- | Xylitol | | | | 15.00 | 15.00 | 3.89 | | | | | | |
| saccharide | Allulose | 15.00 | 15.00 | 3.89 | | | | | | | | | |
| or sugar | | | | | | | | | | | | | |
| alcohol | | | | | | | | | | | | | |
| Comparison | Sucrose | | | | | | | 15.00 | 15.00 | 3.89 | 15.00 | 15.00 | 3.89 |

| | | | | | | | | | | | | |
|---|---|---|---|---|---|---|---|---|---|---|---|---|
| Total | 482.80 | 385.48 | 100.00 | 410.00 | 385.50 | 100.00 | 395.00 | 385.50 | 100.00 | 467.80 | 385.48 | 100.00 |

In the Examples 1 to 18, porcine gelatin, 250 bloom was used. SCF 1 and SCF 2 are commercially available SCFs with a fiber content of at least 70% by weight on a dry solids basis. SCF 3 is a commercially available SCF with a fiber content of at least 85% by weight on a dry solids basis. SCF 4 is a commercially available SCF with a fiber content of at least 85% by weight on a dry solids basis. SCF 5 is a commercially available SCF with a fiber content of at least 90% by weight on a dry solids basis. SCF 6 is a commercially available SCF with a fiber content of at least 97% by weight on a dry solids basis. SCF 7 is a commercially available SCF with a fiber content of at least 90% by weight on a dry solids basis. PDX 1 and 2 are commercially available PDX with a fiber content of at least 90% by weight on a dry solids basis. FOS is a commercially available FOS with a fiber content of at least 90% by weight on a dry solids basis. Allulose was added as commercially available crystalline allulose or syrup.

### Example 19—Texture Analysis

In the following examples, all texture analysis was performed with a TA.XTPlus Texture Analyzer with a TA-52 2 mm diameter probe and a TA-108S-Gi Indexable Gummy Fixture, all of which are available from Texture Technologies Corp. and Stable Micro Systems, Ltd.

Texture analysis was carried out on the gummies prepared in Example 4 14 days, 1 month and 2 months after preparation.

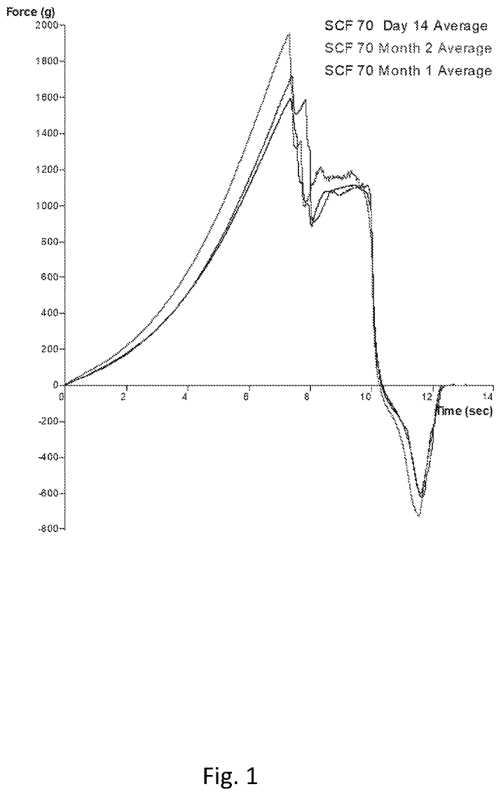

The results of a puncture test are shown in FIG. 1. FIG. 1 shows that gummies prepared with SCF and allulose form a good gelatin set that is consistent 2 months. The increase in the magnitude of the first positive peak for each curve at approximately 7.5 seconds shows that the firmness of the gummies increased over time. The increase in the magnitude of negative peak for each curve at approximately 11.5 seconds shows that the cohesiveness of the gummies increased over time.

Texture analysis was also carried out on the gummies prepared in Examples 4 to 12 was analysed after 14 days, 1 month, 2 months, 3 months and 4 months after preparation.

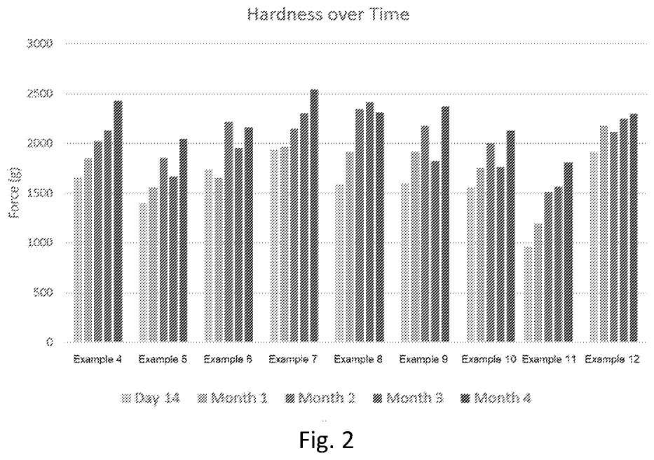

The hardness of the gummies was determined at each stage and the results are shown in FIG. 2. FIG. 2 shows that gummies prepared with allulose and one of SCF, PDX, or inulin a good gelatin set that is consistent over 4 months. The increase in the magnitude of the force shows that the gummies increased in hardness over time. The observed increase in hardness from 14 days after production to 4 months after production is given in Table 2.

TABLE 2
Increase in hardness

| Example | Increase in hardness (%) |
|---|---|
| 4 | 47 |
| 5 | 46 |
| 6 | 24 |
| 7 | 31 |
| 8 | 45 |
| 9 | 48 |
| 10 | 36 |
| 11 | 88 |
| 12 | 20 |

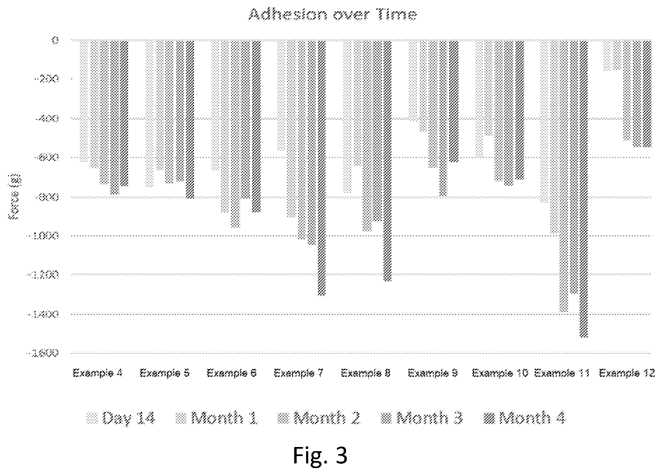

The work of adhesion of the gummies prepared in Examples 4 to 12 was determined at each stage and the results are shown in FIG. 3.

A comparison of FIG. 2 and FIG. 3 show that gummies prepared with allulose and either SCF (Example 7) or FOS (Example 12) that is consistent over 4 months. The increase in the magnitude of the force shows that the gummies increased in hardness over time. The observed increase in hardness from 14 days after production to 4 months after production is given in Table 3.

TABLE 3
Increase in work of adhesion

| | Increase in work of |
|---|---|
| Example | adhesion (%) |
| 4 | 20 |
| 5 | 8 |
| 6 | 32 |
| 7 | 132 |
| 8 | 57 |
| 9 | 48 |
| 10 | 19 |
| 11 | 83 |
| 12 | 69 |

### Example 20—Fiber Blends

Gummies were prepared according to Example 3 except that a blend of FOS and SCF 2 was used in place of the SCF2.

### Example 21—Visual Analysis Over Time

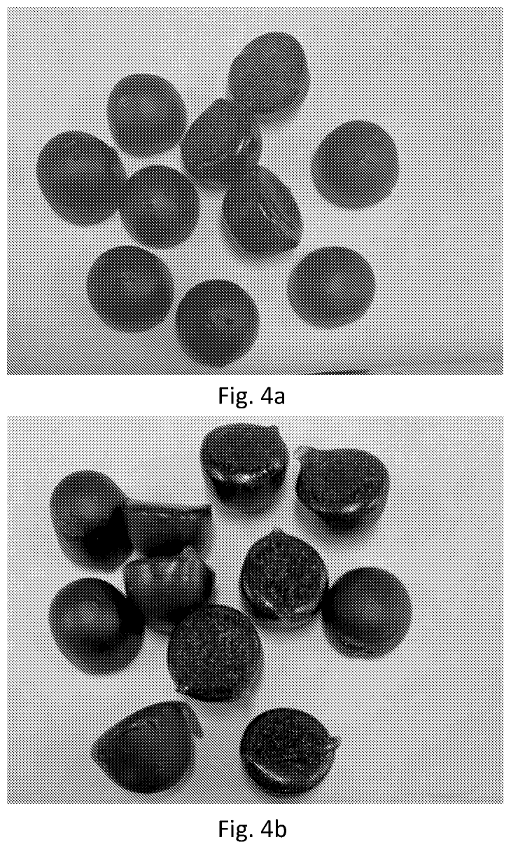

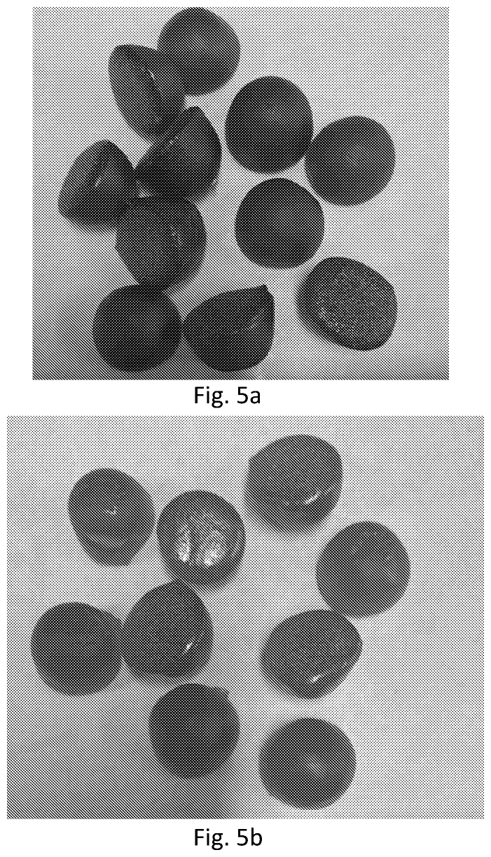

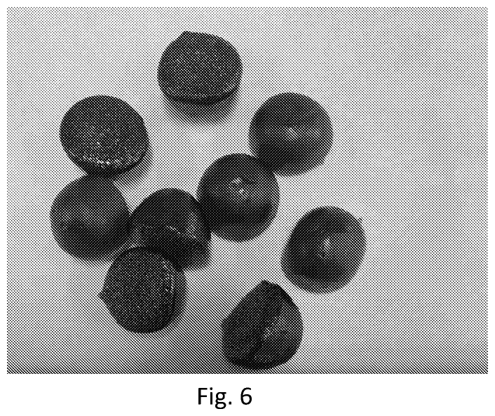

Gummies prepared according to Examples 1, 2, and 18 were stored for at least 11 months and Examples 12 and 20 were stored for at least 18 months and then visually inspected. Photographs of the gummies prepared according to Examples 1, 2, 12, 18, and 20 are provided in FIGS. 4a, 4b, 5a, and 5b, respectively.

Remarkably, the gummies had maintained a very good gelatin set even after 11 months and 18 months. It is therefore demonstrated that gummies according to the invention exhibit a very good gelatin set that is stable for almost a year.

### Comparative Examples 1 and 2

Gummies prepared according to Comparative Example 1 lacked a good firm gelatin set. There was very a low set and the gummies were sticky. Gummies prepared according to Comparative 2 were very sticky. Pieces clumped together due to surface stickiness and there was lack of a gelatin set.

### Examples 22 to 28 and Comparative Example 3

Gummies were prepared with the ingredients/compositions described in Table 4. For each example in Table 4, the first column (Gross (g)) indicates the gross weight in grams of the ingredient as included in the recipe, the middle column (Dry (g)) indicates the net (dry) in grams of the ingredient as included in the recipe, and the final column (% DS) indicates the total dry solids content by weight of the ingredient in the final, unglazed gummies.

Part 1 was prepared by mixing Part 1 ingredients in a cooking kettle and dissolving. Part 2 was prepared by dispersing pectin in the other Part 2 ingredient. Part 2 was added to Part 1 in the kettle while stirring. The contents of the kettle were heated slowly while stirring until starting to boil. The contents of the kettle were boiled for 1 minute to ensure complete dissolution of pectin. Part 3 ingredients were added to the kettle gradually to avoid rapid cooling. The contents of the kettle were boiled at approximately 225° F. to 230° F. (107° C. to 110° C.) with continuous mixing until a solids content of 77-78° Brix was obtained. The slurry was maintained at 185° F. to 190° F. Part 4 ingredients were added with continuous agitation. The finished slurry was transferred to the depositing funnel and immediately deposited into the starch molds. The pectin gummies were dried in a confectionary dryer with airflow at approximately 105° F. to 135° F. (40° C. to 57° C.) for approximately 24 to 48 hours until a until a solids content of 82-84° Brix was obtained. Surface starch was removed with pressurized air and the gummies were coated with a confectionary glaze.

TABLE 4

| | | Example 22 | | | Example 23 | | | Example 24 | | | Example 25 | | |
|---|---|---|---|---|---|---|---|---|---|---|---|---|---|
| | | Gross | Dry | % | Gross | Dry | % | Gross | Dry | % | Gross | Dry | % |
| | Ingredients | (g) | (g) | DS | (g) | (g) | DS | (g) | (g) | DS | (g) | (g) | DS |
| Part 1 | Water | 359.10 | 0.00 | 0.00 | 209.10 | 0.00 | 0.00 | 337.35 | 0.00 | 0.00 | 357.45 | 0.00 | 0.00 |
| | Sodium citrate | 3.00 | 3.00 | 0.37 | 3.00 | 3.00 | 0.37 | 3.00 | 3.00 | 0.37 | 3.00 | 3.00 | 0.37 |
| | Citric Acid | | | | | | | | | | | | |
| Part 2 | Liquid Allulose | 150.00 | 106.50 | 13.05 | 150.00 | 106.50 | 13.03 | 150.00 | 106.50 | 13.04 | 150.00 | 106.50 | 13.03 |
| | Crystalline Allulose | | | | | | | | | | | | |
| | Granulated sugar | | | | | | | | | | | | |
| | Pectin | 21.45 | 20.40 | 2.50 | 21.45 | 20.40 | 2.50 | 21.45 | 20.38 | 2.49 | 21.45 | 20.38 | 2.49 |
| Part 3 | Liquid Allulose | 180.00 | 127.80 | 15.66 | 180.00 | 127.80 | 15.64 | 180.00 | 127.80 | 15.64 | 180.00 | 127.80 | 15.64 |
| | Crystalline Allulose | | | | | | | | | | | | |
| | Soluble Corn Fiber | 765.00 | 550.80 | 67.49 | 450.00 | 324.00 | 39.64 | | | | 765.00 | 550.80 | 67.40 |
| | Fructo-oligosaccharides | | | | 240.00 | 228.00 | 27.90 | | | | | | |
| | Polydextrose | | | | | | | 786.45 | 550.52 | 67.38 | | | |
| | Corn Syrup | | | | | | | | | | | | |
| | Granulated sugar | | | | | | | | | | | | |
| | Water | | | | 225.00 | 0.00 | 0.00 | | | | | | |
| Part 4 | Citric Acid | 12.00 | 6.00 | 0.74 | 12.00 | 6.00 | 0.73 | 14.25 | 7.13 | 0.87 | 14.25 | 7.13 | 0.87 |
| | Flavor | 7.50 | 0.75 | 0.09 | 7.50 | 0.75 | 0.09 | 7.50 | 0.75 | 0.09 | 7.50 | 0.75 | 0.09 |
| | Sweetener | 0.68 | 0.68 | 0.08 | 0.68 | 0.68 | 0.08 | 0.90 | 0.90 | 0.11 | 0.75 | 0.75 | 0.09 |
| | Color | 1.20 | 0.15 | 0.02 | 1.20 | 0.15 | 0.02 | 0.60 | 0.06 | 0.01 | 1.20 | 0.12 | 0.01 |
| Total | | 1499.93 | 816.08 | 100.00 | 1499.93 | 817.28 | 100.00 | 1501.50 | 817.03 | 100.00 | 1500.60 | 817.22 | 100.00 |
| | | Example 26 | | | Example 27 | | | Example 28 | | | Comparative Example 3 | | |
| | | Gross | Dry | % | Gross | Dry | % | Gross | Dry | % | Gross | Dry | % |
| | Ingredients | (g) | (g) | DS | (g) | (g) | DS | (g) | (g) | DS | (g) | (g) | DS |
| Part 1 | Water | 209.10 | 0.00 | 0.00 | 321.60 | 0.00 | 0.00 | 237.40 | 0.00 | 0.00 | 157.10 | 0.00 | 0.00 |
| | Sodium citrate | 3.00 | 3.00 | 0.37 | 3.00 | 3.00 | 0.37 | 3.00 | 3.00 | 0.55 | 3.00 | 3.00 | 0.40 |
| | Citric Acid | | | | | | | 1.50 | 1.50 | 0.28 | | | |
| Part 2 | Liquid Allulose | 150.00 | 106.50 | 13.09 | 150.00 | 106.50 | 13.07 | | | | | | |
| | Crystalline Allulose | | | | | | | 71.00 | 71.00 | 13.04 | | | |
| | Granulated sugar | | | | | | | | | | 123.50 | 123.50 | 16.58 |
| | Pectin | 16.50 | 15.68 | 1.93 | 21.45 | 20.38 | 2.50 | 12.30 | 11.69 | 2.15 | 15.50 | 14.73 | 1.98 |
| Part 3 | Liquid Allulose | 180.00 | 127.80 | 15.71 | 180.00 | 127.80 | 15.68 | | | | | | |
| | Crystalline Allulose | | | | | | | 85.20 | 85.20 | 15.65 | | | |
| | Soluble Corn Fiber | 450.00 | 324.00 | 39.82 | | | | 300.00 | 216.00 | 39.68 | | | |
| | Fructo-oligosaccharides | 240.00 | 228.00 | 28.02 | 577.50 | 548.63 | 67.32 | 160.00 | 152.00 | 27.92 | | | |
| | Polydextrose | | | | | | | | | | | | |
| | Corn Syrup | | | | | | | | | | 428.50 | 344.09 | 46.20 |
| | Granulated sugar | | | | | | | | | | 250.00 | 250.00 | 33.57 |
| | Water | 225.00 | 0.00 | 0.00 | 225.00 | 0.00 | 0.00 | 50.00 | 0.00 | 0.00 | | | |
| Part 4 | Citric Acid | 14.25 | 7.13 | 0.88 | 14.25 | 7.13 | 0.87 | 6.00 | 3.00 | 0.55 | 18.00 | 9.00 | 1.21 |
| | Flavor | 7.50 | 0.75 | 0.09 | 7.50 | 0.75 | 0.09 | 5.00 | 0.50 | 0.09 | 4.00 | 0.40 | 0.05 |
| | Sweetener | 0.75 | 0.75 | 0.09 | 0.75 | 0.75 | 0.09 | 0.45 | 0.45 | 0.08 | | | |
| | Color | 0.60 | 0.06 | 0.01 | 0.60 | 0.06 | 0.01 | 0.80 | 0.08 | 0.01 | 0.80 | 0.08 | 0.01 |

| | | | | | | | | | | | | |
|---|---|---|---|---|---|---|---|---|---|---|---|---|
| Total | 1496.70 | 813.66 | 100.00 | 1501.65 | 814.99 | 100.00 | 932.65 | 544.42 | 100.00 | 1000.40 | 744.79 | 100.00 |

In Examples 22 to 28 and Comparative Example 3, sodium citrate dehydrate (fine) was used. Pectin is a commercially available pectin extracted from citrus peel. Soluble Corn Fiber is a commercially available SCF with a fiber content of at least 85% by weight on a dry solids basis. Polydextrose is commercially available PDX with a fiber content of at least 90% by weight on a dry solids basis. Fructo-oligosaccharides were provided as a commercially available FOS. Allulose was added as commercially available crystalline allulose or syrup. Granulated sugar and corn syrup are commercially available products. Citric acid was added a 50% solution. Colors, sweeteners and flavors are commercially available.

### Example 29—Evaluation of Sugar Free Pectin Gummies

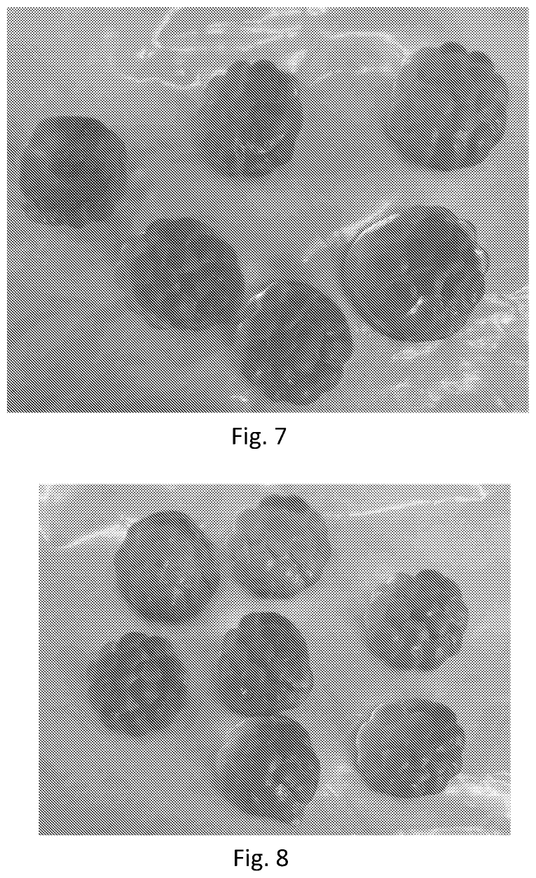

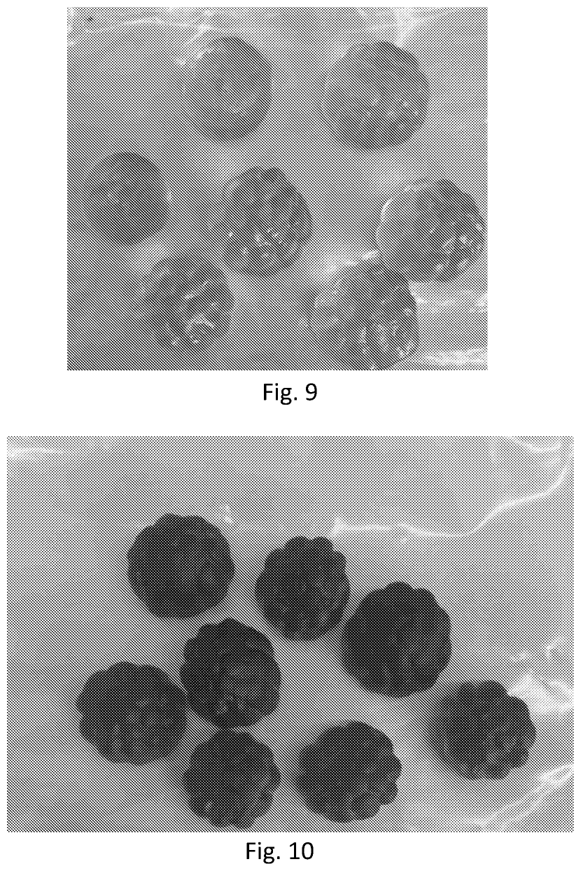

The gummies of Examples 25 to 27 and Comparative Example 3 were stored for 1 to 6 weeks and then evaluated. Their dry solids content, water activity and pH were determined. The results are shown in Table 5. Photographs of the gummies are shown in FIGS. 7 to 10.

TABLE 5

| | Saccharide/fiber | Dry solids | | Water | |
|---|---|---|---|---|---|
| | blend | content (°Brix) | pH | Activity | Observations |
| Example 25 | Allulose/SCF | 82, 81 | 3.74 | 0.64 | Slightly longer texture, very low |
| | | | | | stickiness when chewed, no |
| | | | | | surface stickiness, good |
| | | | | | sweetness and flavor |
| Example 26 | Allulose/SCF/FOS | 82, 83 | 3.75 | 0.62 | Nice, clean and short bite, no |
| | | | | | stickiness, excellent sweetness |
| | | | | | and flavor, nice color |
| Example 27 | Allulose/FOS | 84, 83 | 3.65 | 0.58 | Excellent texture, slight surface |
| | | | | | stickiness, no interior stickiness, |
| | | | | | sugar like sweetness |
| Comparative | Sucrose/corn | 84, 85 | 3.61 | 0.61 | Nice pectin set, short texture, no |
| Example 3 | syrup | | | | surface or interior stickiness, nice |
| | | | | | sweetness and flavor, slight sign |
| | | | | | of crystallization |

### Example 30—Sensory Analysis of Gummies

Sensory analysis was conducted to identify the most-liked gummies. 3 products were tested:
Corn Fiber/Sugar/Pectin (50%/46%/2.5% on a dry solids basis, balance in balance in sweetener, color, citric acid and sodium citrate)
SCF/Allulose/Pectin (65%/30%/2.75% on a dry solids basis, balance in sweetener, color, citric acid and sodium citrate)
FOS/Allulose/Pectin (65%/30%/2.75% on a dry solids basis, balance in sweetener, color, citric acid and sodium citrate)

155 respondents were recruited according to the following recruitment criteria:
Ages 21-65
   Min 40%/Max 60% Ages 21-39
   Min 40%/Max 60% Ages 40-65
Gender
   Min 25% Male, Max 75% Female, Max 5% Non-Binary
Ethnicity
   Min 20% Non-Caucasian, Max 80% Caucasian
Household income $35K+
Primary Supplements Purchaser
Health Conditions
   Min 33% Diabetic or Pre-Diabetic, Max 67% Non-Diabetic
Diet
   Min 40% Actively striving to reduce sugar in diet, Max 60% Not reducing sugar
Category Usage: Daily users of gummy dietary supplements
Diabetic/pre-diabetic allowed to be weekly or more often users of gummy dietary supplements
Like and willing to try low sugar/sugar free gummies in a berry flavor
Passed competitive employment screen
No past participation in the past: 2 months (Quant/Qual)
No food allergies

Respondents evaluated the products in a fully rotated and balanced presentation.

Respondents were asked to answer the following questions.
Q1. OVERALL, how much do you LIKE or DISLIKE these gummies? (1=Dislike Extremely . . . 9=Like Extremely)
Q2: How well does this product meet your EXPECTATIONS of GUMMIES? (1=Much Worse Than Expected . . . 5=Much Better Than Expected)

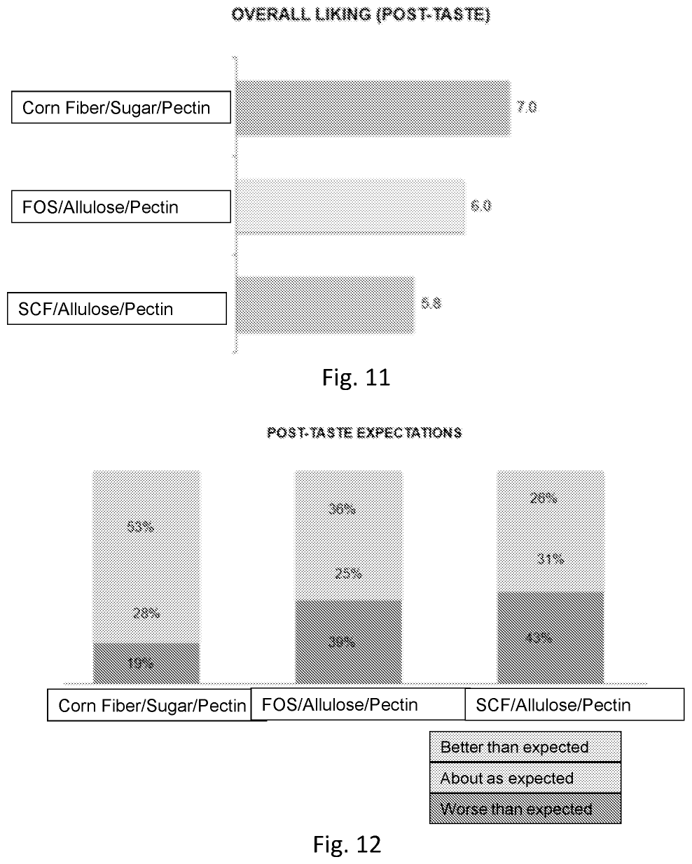

The results for Q1 are shown in FIG. 11. The results for Q2 are shown in FIG. 12. Full Sugar Pectin was most liked and best met/exceeded consumers' expectations. FOS Pectin comprised the second tier of most liked products after Full Sugar Pectin. The same order of preference was found in diabetic (n=45) Respondents as in the whole cohort (n=155).

Respondents were asked how much they liked or disliked five attributes (overall appearance, overall flavor, overall texture, feel to the touch, and mouthfeel) of the gummies and assign a score between 1=Dislike Extremely . . . 9=Like Extremely. The results are shown in Table 6.

TABLE 6

| Mean Liking Attributes | CF/Sugar/ | FOS/Allulose/ | SCF/Allulose/ |
|---|---|---|---|
| n = 155 | Pectin | Pectin | Pectin |
| Overall Appearance | 7.0 | 5.6 | 6.3 |
| Overall Flavor | 6.8 | 5.9 | 5.4 |
| Overall Texture | 6.9 | 6.2 | 4.2 |
| Feel to the Touch | 7.1 | 6.3 | 5.3 |
| Mouthfeel | 6.9 | 6.1 | 4.3 |

Full Sugar Pectin gummy was very well liked for all attributes. FOS Pectin was in the second tier of liking for overall flavor, overall texture, feel to the touch, and mouthfeel.

### EMBODIMENTS

Embodiment 1. A gummy comprising:
soluble fiber in an amount of from about 40% to about 90% by weight on a dry solids basis;
a gelling agent in an amount of from about 3% to about 25% by weight on a dry solids basis;
a low-molecular weight saccharide or sugar alcohol in an amount of from about 1% to about 45% by weight on a dry solids basis; and
water;
wherein the gummy has a total dry solids content of from about 75% to about 90% by weight.

Embodiment 2. A gummy according to Embodiment 1, wherein the soluble fiber comprises any selected from the group consisting of polydextrose, hydrogenated polydextrose, soluble corn fiber, fructans, galactooligosaccharides, resistant dextrin, galactomannans, hydrolyzed galactomannans, and a combination of two or more of any of the foregoing,
preferably wherein the soluble fiber is selected from the group consisting of polydextrose, fructans, galactooligosaccharides, hydrogenated polydextrose, soluble corn fiber, and a combination of two or more of any of the foregoing.

Embodiment 3. A gummy according to Embodiment 1 or Embodiment 2, wherein the comprises any selected from the group consisting of gelatin, alginic acid and salts thereof, carrageenan, locust bean gum, curdlan, pectin, and a combination of any two or more of the foregoing,
preferably wherein the gelling agent is gelatin.

Embodiment 4. A gummy according to any of Embodiments 1 to 3, wherein the low-molecular weight saccharide or sugar alcohol comprises any selected from the group consisting of a monosaccharide, a disaccharide, a sugar alcohol, and a combination of any two or more of the foregoing;
more preferably wherein the low-molecular weight saccharide or sugar alcohol comprises any selected from the group consisting of: allose, altrose, galactose, galactose disaccharides, dextrose, dextrose disaccharides (e.g. maltose, isomaltose), gulose, idose, mannose, talose, fructose, fructose disaccharides, allulose, sorbose, tagatose, fucose, fuculose, rhamnose, arabitol, erythritol, glycerol, isomalt, lactitol, maltitol, mannitol, sorbitol, xylitol, and a combination of two or more of any of the foregoing,
more preferably wherein the low-molecular weight saccharide or sugar alcohol comprises any selected from the group consisting of: dextrose, dextrose disaccharides (e.g. maltose, isomaltose), fructose, allulose, tagatose, erythritol, maltitol, sorbitol, xylitol, and a combination of two or more of any of the foregoing.

Embodiment 5. A gummy according to any of Embodiments 1 to 4, wherein gummy has a total dry solids content by weight of from about 75% to about 88%, from about 77% to about 86%, from about 79% to about 85%, from about 80% to about 84%, or from about 80% to about 82%.

Embodiment 6. A gummy according to any of Embodiments 1 to 5, wherein the gummy comprises the soluble fiber in an amount of from about 44% to about 87%, from about 47% to about 85%, from about 50% to about 75%, from about 52% to about 70%, from about 55% to about 68%, from about 55% to about 60%, from about 60% to about 85%, from about 70% to about 85%, or from about 75% to about 85%, by weight on a dry solids basis.

Embodiment 7. A gummy according to any of Embodiments 1 to 6, wherein the gummy comprises the gelling agent in an amount of from about 4% to about 20%, from about 5% to about 15%, from about 6% to about 12%, or from about 8% to about 12%, by weight on a dry solids basis.

Embodiment 8. A gummy according to any of Embodiments 1 to 7, wherein the gummy comprises the low-molecular weight saccharide or sugar alcohol in an amount of from about 1.5% to about 42%, from about 2% to about 40%, from about 3% to about 36%, from about 5% to about 35%, from about 7% to about 30%, from about 8% to about 22%, from about 9% to about 20%, or from about 10% to about 18% by weight on a dry solids basis.

Embodiment 9. A gummy according to any of Embodiments 1 to 8, wherein the gummy comprises:
the soluble fiber in an amount of from about 50% to about 85% by weight on a dry solids basis;
the gelling agent in an amount of from about 8% to about 12% by weight on a dry solids basis;
the low-molecular weight saccharide or sugar alcohol in an amount of from about 8% to about 42% by weight on a dry solids basis; and
wherein the gummy has a total dry solids content of from about 80% to about 84%.

Embodiment 10. A gummy according Embodiment 9, wherein the gummy comprises the soluble fiber in an amount of from about 50% to about 60% by weight on a dry solids basis.

Embodiment 11. A gummy according Embodiment 9, wherein the gummy comprises:
the soluble fiber in an amount of from about 60% to about 70% by weight on a dry solids basis; and
the low-molecular weight saccharide or sugar alcohol in an amount of from about 8% to about 32% by weight on a dry solids basis.

Embodiment 12. A gummy according Embodiment 9, wherein the gummy comprises:
the soluble fiber in an amount of from about 70% to about 80% by weight on a dry solids basis; and
the low-molecular weight saccharide or sugar alcohol in an amount of from about 8% to about 22% by weight on a dry solids basis.

Embodiment 13. A gummy according to any of Embodiments 1 to 12, wherein the gummy comprises one or more additional ingredients,
preferably wherein the gummy comprises the one or more additional ingredients in an aggregate amount of up to 2% by weight on a dry solids basis.

Embodiment 14. A gummy according to Embodiment 13, wherein the one or more additional ingredients comprise one or more natural and/or synthetic high intensity sweeteners;
preferably selected from the group consisting of stevia extract, monk fruit extract, brazzein, thaumatin, monellin, monatin and its salts, glycyrrhizic acid and its salts, sucralose, aspartame and acesulfame potassium.

Embodiment 15. A gummy according to Embodiment 13 or Embodiment 14, wherein the one or more additional ingredients comprise any one or more of any selected from the group consisting of: bulking agents; fats; oils; milk and/or other dairy products; alcohol; gums; natural and/or synthetic colorants; natural and/or synthetic flavorants; salt; spices; fruits and fruit-derived products; vegetables and vegetable-derived products; legumes and legume-derived products; nuts and nut-derived products; preservatives; stabilizers; antioxidants; emulsifiers; non-gelling proteins; amino acids; and acidulants, such as acetic acid, citric acid, phosphoric acid, lactic acid, malic acid, fumaric acid, ascorbic acid, tartaric acid and hydrochloric acid.

Embodiment 16. A gummy according to any of Embodiments 13 to 15, wherein the one or more additional ingredients comprise any one or more nutraceuticals selected from the group consisting of:
vitamins, such as Vitamin A, Vitamin C, Vitamin D, Vitamin E, Vitamin K, Vitamin B1 (thiamine), Vitamin B2 (riboflavin), Vitamin B3 (niacin), Vitamin B6 (pyridoxine), Vitamin B12 (cyanocobalamin), Pantothenic acid (B5), Biotin (B7), Folate (folic acid or B9);
minerals or electrolytes, such as nutritionally acceptable compounds of calcium, phosphorus, potassium, sodium, chloride, magnesium, iron, zinc, iodine, sulfur, cobalt, copper, fluoride, manganese, and selenium; and
bioactive compounds, such as polyphenols, carotenoids, vitamins, omega-3 fatty acids, organic acids, nucleosides and nucleotides, and phytosterols, in particular lycopene, resveratrol, lignan, and tannins,
preferably wherein the gummy comprises the one or more nutraceuticals in an amount suitable to deliver about 10%, about 11%, about 12.5%, about 14%, about 20%, about 25%, about 33%, about 50%, about 75%, or about 100% daily value of the one or more nutraceuticals per gummy.

Embodiment 17. A gummy according to any of Embodiments 1 to 16, wherein the gummy is substantially free of sucrose, substantially free of maltodextrin, or substantially free of sucrose and maltodextrin.

Embodiment 18. A gummy according to any of Embodiments 1 to 17, wherein the gummy consists essentially of:
the soluble fiber;
the gelling agent;
the low-molecular weight saccharide or sugar alcohol comprises which is any selected from the group consisting of: allose, altrose, galactose, galactose disaccharides, dextrose, dextrose disaccharides (e.g. maltose, isomaltose), gulose, idose, mannose, talose, fructose, fructose disaccharides, allulose, sorbose, tagatose, fucose, fuculose, rhamnose, arabitol, erythritol, glycerol, isomalt, lactitol, maltitol, mannitol, sorbitol, xylitol, and a combination of two or more of any of the foregoing;
water; and
optionally one or more additional ingredients in an aggregate amount of up to 2% by weight on a dry solids basis.

Embodiment 19. A process for preparing a gummy comprising the steps of:
a) dispersing a soluble fiber; one or more low-molecular weight saccharides, sugar alcohols, or a combination thereof; a gelling agent in water to provide a gelling composition having:
a soluble fiber in an amount of from about 40% to about 90% by weight on a dry solids basis;
a gelling agent in an amount of from about 3% to about 25% by weight on a dry solids basis;
a low-molecular weight saccharide or sugar alcohol in an amount of from about 1% to about 45% by weight on a dry solids basis; and
b) drying the gelling composition to provide a gummy having a total dry solids content of from about 75% to about 90%.

1. A gummy comprising:
soluble fiber in an amount of from about 40% to about 90% by weight on a dry solids basis;
a gelling agent in an amount of from about 1% to about 25% by weight on a dry solids basis;
a low-molecular weight saccharide or sugar alcohol in an amount of from about 1% to about 45% by weight on a dry solids basis; and
water;
wherein the gummy has a total dry solids content of from about 75% to about 90% by weight.

2. A gummy according to claim 1, wherein the low-molecular weight saccharide is allulose.

3. A gummy according to claim 1 or 2, wherein the gummy is substantially free of sucrose.

4. A gummy according to any of claims 1 to 3, wherein the gummy is substantially free of maltodextrin.

5. A gummy according to any of claims 1 to 4, wherein the gummy is substantially free of glucose.

6. A gummy according to any of claims 1 to 5, wherein the gummy is substantially free of fructose.

7. A gummy according to any of claims 1 to 6, wherein the gummy is substantially free of maltose.

8. A gummy according to any of claims 1 to 7, wherein the soluble fiber comprises any selected from the group consisting of polydextrose, hydrogenated polydextrose, soluble corn fiber, fructans, galactooligosaccharides, resistant dextrin, galactomannans, hydrolyzed galactomannans, and a combination of two or more of any of the foregoing.

9. A gummy according to any of claims 1 to 8, wherein the soluble fiber comprises any selected from the group consisting of polydextrose, fructans, galactooligosaccharides, hydrogenated polydextrose, soluble corn fiber, and a combination of two or more of any of the foregoing.

10. A gummy according to any of claims 1 to 9, wherein the gelling agent is selected from the group consisting of gelatin, alginic acid and salts thereof, carrageenan, locust bean gum, curdlan, pectin, and a combination of any two or more of the foregoing.

11. A gummy according to any of claims 1 to 10, wherein the gelling agent is gelatin.

12. A gummy according to any of claims 1 to 10, wherein the gelling agent is pectin.

13. A gummy according to any of claims 1 to 12, wherein the low-molecular weight saccharide or sugar alcohol comprises any selected from the group consisting of a monosaccharide, a disaccharide, a sugar alcohol, and a combination of any two or more of the foregoing.

14. A gummy according to any of claims 1 to 13, wherein the low-molecular weight saccharide or sugar alcohol comprises any selected from the group consisting of: allose, altrose, galactose, galactose disaccharides, dextrose, dextrose disaccharides (e.g. maltose, isomaltose), gulose, idose, mannose, talose, fructose, fructose disaccharides, allulose, sorbose, tagatose, fucose, fuculose, rhamnose, arabitol, erythritol, glycerol, isomalt, lactitol, maltitol, mannitol, sorbitol, xylitol, and a combination of two or more of any of the foregoing,

15. A gummy according to any of claims 1 to 14, wherein the low-molecular weight saccharide or sugar alcohol comprises any selected from the group consisting of: dextrose, dextrose disaccharides (e.g. maltose, isomaltose), fructose, allulose, tagatose, erythritol, maltitol, sorbitol, xylitol, and a combination of two or more of any of the foregoing.

16. A gummy according to any of claims 1 to 15, wherein gummy has a total dry solids content of from about 75% to about 88%, from about 77% to about 86%, from about 79% to about 85%, from about 80% to about 84%, or from about 80% to about 82%.

17. A gummy according to any of claims 1 to 16, wherein the gummy the comprises the soluble fiber in an amount of from about 44% to about 87%, from about 47% to about 85%, from about 50% to about 75%, from about 52% to about 70%, from about 55% to about 68%, from about 55% to about 60%, from about 60% to about 85%, from about 70% to about 85%, or from about 75% to about 85%, by weight on a dry solids basis.

18. A gummy according to any of claims 1 to 17, wherein the gummy comprises the gelling agent in an amount of from about 4% to about 20%, from about 5% to about 15%, from about 6% to about 12%, or from about 8% to about 12%, by weight on a dry solids basis.

19. A gummy according to any of claims 1 to 18, wherein the gummy comprises the low-molecular weight saccharide or sugar alcohol in an amount of from about 1.5% to about 42%, from about 2% to about 40%, from about 3% to about 36%, from about 5% to about 35%, from about 7% to about 30%, from about 8% to about 22%, from about 9% to about 20%, or from about 10% to about 18% by weight on a dry solids basis.

20. A gummy according to any of claims 1 to 19, wherein the gummy comprises:
the soluble fiber in an amount of from about 50% to about 85% by weight on a dry solids basis;
the gelling agent in an amount of from about 8% to about 12% by weight on a dry solids basis;
the low-molecular weight saccharide or sugar alcohol in an amount of from about 8% to about 42% by weight on a dry solids basis; and
wherein the gummy has a total dry solids content of from about 80% to about 84%.

21. A gummy according claim 20, wherein the gummy comprises:
the soluble fiber in an amount of from about 50% to about 60% by weight on a dry solids basis.

22. A gummy according claim 21, wherein the gummy comprises:
the soluble fiber in an amount of from about 60% to about 70% by weight on a dry solids basis; and
the low-molecular weight saccharide or sugar alcohol in an amount of from about 8% to about 32% by weight on a dry solids basis.

23. A gummy according claim 21, wherein the gummy comprises:
the soluble fiber in an amount of from about 70% to about 80% by weight on a dry solids basis; and
the low-molecular weight saccharide or sugar alcohol in an amount of from about 8% to about 22% by weight on a dry solids basis.

24. A gummy according to any of claims 1 to 23, wherein the gummy comprises one or more additional ingredients.

25. A gummy according to any claim 24, wherein the gummy comprises the one or more additional ingredients in an aggregate amount of up to 2% by weight on a dry solids basis.

26. A gummy according to claim 24 or 25, wherein the one or more additional ingredients comprise one or more natural and/or synthetic high intensity sweeteners;
preferably selected from the group consisting of stevia extract, monk fruit extract, brazzein, thaumatin, monellin, monatin and its salts, glycyrrhizic acid and its salts, sucralose, aspartame and acesulfame potassium.

27. A gummy according to any of claims 24 to 26, wherein the one or more additional ingredients comprise one or more of any selected from the group consisting of: bulking agents; fats; oils; milk and/or other dairy products; alcohol; gums; natural and/or synthetic colorants; natural and/or synthetic flavorants; salt; spices; fruits and fruit-derived products; vegetables and vegetable-derived products; legumes and legume-derived products; nuts and nut-derived products; preservatives; stabilizers; antioxidants; emulsifiers; non-gelling proteins; amino acids; and acidulants, such as acetic acid, citric acid, phosphoric acid, lactic acid, malic acid, fumaric acid, ascorbic acid, tartaric acid and hydrochloric acid.

28. A gummy according to any of claims 24 to 27, wherein the one or more additional ingredients comprise one or more nutraceuticals selected from the group consisting of:
vitamins, such as Vitamin A, Vitamin C, Vitamin D, Vitamin E, Vitamin K, Vitamin B1 (thiamine), Vitamin B2 (riboflavin), Vitamin B3 (niacin), Vitamin B6 (pyridoxine), Vitamin B12 (cyanocobalamin), Pantothenic acid (B5), Biotin (B7), Folate (folic acid or B9);
minerals or electrolytes, such as nutritionally acceptable compounds of calcium, phosphorus, potassium, sodium, chloride, magnesium, iron, zinc, iodine, sulfur, cobalt, copper, fluoride, manganese, and selenium; and
bioactive compounds, such as polyphenols, carotenoids, vitamins, omega-3 fatty acids, organic acids, nucleosides and nucleotides, and phytosterols, in particular lycopene, resveratrol, lignan, and tannins,

29. A gummy according to claim 28, wherein the gummy comprises the one or more nutraceuticals in an amount suitable to deliver about 10%, about 11%, about 12.5%, about 14%, about 20%, about 25%, about 33%, about 50%, about 75%, or about 100% daily value of the one or more nutraceuticals per gummy.

30. A gummy according to any of claims 1 to 29, wherein the gummy consists essentially of:
the soluble fiber;
the gelling agent;
the low-molecular weight saccharide or sugar alcohol which is any selected from the group consisting of: allose, altrose, galactose, galactose disaccharides, dextrose, dextrose disaccharides (e.g. maltose, isomaltose), gulose, idose, mannose, talose, fructose, fructose disaccharides, allulose, sorbose, tagatose, fucose, fuculose, rhamnose, arabitol, erythritol, glycerol, isomalt, lactitol, maltitol, mannitol, sorbitol, xylitol, and a combination of two or more of any of the foregoing;
water; and
optionally one or more additional ingredients in an aggregate amount of up to 2% by weight on a dry solids basis.

31. A gummy according to any of claims 1 to 30, wherein the soluble fiber is soluble corn fiber, fructo-oligosaccharides or a combination thereof.

32. A gummy according to any of claims 1 to 32, wherein the soluble fiber is present in the gummy in an amount of from about 60% to about 80% by weight on a dry solids basis, preferably from about 55% to 75% by weight on a dry solids basis.

33. A gummy according to any of claims 1 to 33, wherein the low-molecular weight saccharide or sugar alcohol is allulose and is present in an amount of from about 10% to about 45% by weight on a dry solids basis, preferably from about 20% to about 35% by weight on a dry solids basis.

34. A gummy according to any of claims 1 to 33, wherein the gelling agent is pectin.

35. A gummy according to any of claims 1 to 34, wherein the gummy comprises the gelling agent in an amount of from about 1% to about 5% by weight on a dry solids basis.

36. A process for preparing a gummy comprising the steps of:
a) dispersing a soluble fiber; one or more low-molecular weight saccharides, sugar alcohols, or a combination thereof; a gelling agent in water to provide a gelling composition having:
a soluble fiber in an amount of from about 40% to about 90% by weight on a dry solids basis;
a gelling agent in an amount of from about 1% to about 25% by weight on a dry solids basis;
a low-molecular weight saccharide or sugar alcohol in an amount of from about 1% to about 45% by weight on a dry solids basis; and
b) drying the gelling composition to provide a gummy having a total dry solids content of from about 75% to about 90%.

37. A gummy comprising:
fructo-oligosaccharides (FOS) in an amount of from about 40% to about 99% by weight on a dry solids basis;
a gelling agent in an amount of from about 1% to about 25% by weight on a dry solids basis; and
water;
wherein the gummy has a total dry solids content of from about 75% to about 90%.

38. A gummy according to claim 37, wherein the additional soluble fiber comprises any selected from the group consisting of polydextrose, fructans other than FOS, galactooligosaccharides, hydrogenated polydextrose, soluble corn fiber, and a combination of two or more of any of the foregoing.

39. A gummy according to any of claim 37 or 38, wherein the gelling agent is pectin.

40. A gummy according to any of claims 37 to 39, wherein gummy comprises the gelling agent in an amount of from about 1% to about 3% by weight on a dry solids basis.

41. A process for preparing a gummy comprising the steps of:
a) dispersing fructo-oligosaccharides (FOS) and a gelling agent in water to provide a gelling composition having:
FOS in an amount of from about 40% to about 99% by weight on a dry solids basis;
a gelling agent in an amount of from about 1% to about 25% by weight on a dry solids basis; and
b) drying the gelling composition to provide a gummy having a total dry solids content of from about 75% to about 90%. A low-molecular weight saccharide or sugar alcohol may also be added in step a) to give a gelling composition having a low-molecular weight saccharide or sugar alcohol in an amount of from about 1% to about 45% by weight on a dry solids basis.
